(19) United States
(12) Patent Application Publication
(10) Pub. No.: US 2025/0191320 A1
(43) Pub. Date: Jun. 12, 2025

(54) DATA PROCESSING METHOD AND APPARATUS, COMPUTER DEVICE, AND READABLE STORAGE MEDIUM

(71) Applicant: TENCENT TECHNOLOGY (SHENZHEN) COMPANY LIMITED, Shenzhen (CN)

(72) Inventor: Liang ZHANG, Shenzhen (CN)

(21) Appl. No.: 19/055,433

(22) Filed: Feb. 17, 2025

Related U.S. Application Data
(63) Continuation of application No. PCT/CN2023/131019, filed on Nov. 10, 2023.

(30) Foreign Application Priority Data
Jan. 19, 2023 (CN) 202310100656.X

(51) Int. Cl. G06T 19/20; G06T 7/73; G06T 13/40

(52) U.S. Cl. CPC G06T 19/20; G06T 7/73; G06T 13/40; G06T 2207/20044; G06T 2219/2016

(57) ABSTRACT

Embodiments of this application provide a data processing method and apparatus, a computer device, and a readable storage medium. The method includes obtaining a target video frame and a reference video frame from an inputted video, and extracting a joint point of a detected object separately from the target video frame and the reference video frame; obtaining a detected rotation angle value configured for representing a joint point change magnitude of the joint point from the reference video frame to the target video frame; determining, based on an angle value range and a confidence range, a virtual rotation magnitude configured for controlling the joint point change magnitude of the joint point within a preset magnitude range; and adjusting the detected rotation angle value based on the virtual rotation magnitude to obtain an adjusted rotation angle value corresponding to the joint point.

### RELATED APPLICATIONS

This application is a continuation of PCT Application No. PCT/CN2023/131019, filed on Nov. 10, 2023, which claims priority to Chinese Patent Application No. 202310100656X, filed with the China National Intellectua2023,operty Administration on Jan. 19, 2023 and entitled “DATA PROCESSING METHOD AND APPARATUS, COMPUTER DEVICE, AND READABLE STORAGE MEDIUM”, which are incorporated by reference in their entirety.

### FIELD OF THE TECHNOLOGY

Embodiments of this application relate to the field of computer technologies, and in particular, to a data processing method and apparatus, a computer device, and a readable storage medium.

### BACKGROUND OF THE DISCLOSURE

In an object driving method, a joint point of a detected object may be obtained separately from a target video frame and a reference video frame. Then, a detected rotation angle value configured for representing a joint point change magnitude of the joint point from the reference video frame to the target video frame can be obtained. By using the detected rotation angle value, object driving is performed on a virtual object in a reference virtual image associated with the reference video frame to obtain the virtual object in a target virtual image associated with the target video frame.

However, due to technical limitations, a posture of the detected object cannot be corrected detected in some situations, resulting in low accuracy of the obtained detected rotation angle value. When the object driving is performed based on the detected rotation angle value with low accuracy, it inevitably leads to unstable object driving, for example, resulting in virtual objects with inconsistent movements and postures that are structurally problematic.

### SUMMARY

Embodiments of this application provide a data processing method and apparatus, a computer device, and a readable storage medium, which can improve stability of object driving of a virtual object.

One aspect of an embodiment of this application provides a data processing method, including: obtaining a target video frame and a reference video frame from an inputted video, and extracting a joint point of a detected object separately from the target video frame and the reference video frame, the reference video frame being a previous video frame of the target video frame; obtaining a rotation angle value representing a joint point change magnitude of the joint point from the reference video frame to the target video frame; determining, based on an angle value range to which the rotation angle value belongs and a confidence range to which target position confidence of the joint point in the target video frame belongs, a virtual rotation magnitude for controlling the joint point change magnitude of the joint point within a preset magnitude range; and adjusting the rotation angle value based on the virtual rotation magnitude to obtain an adjusted rotation angle value corresponding to the joint point.

Another aspect of an embodiment of this application provides a computer device, including a processor and a memory. The processor and the memory are connected, the memory is configured to store a computer program, and the computer program, when executed by the processor, causes the computer device to perform the method provided in embodiments of this application.

An aspect of an embodiment of this application provides a non-transitory computer-readable storage medium, having a computer program stored thereon. The computer program is loadable and executable by a processor, to cause a computer device having the processor to perform the method provided in embodiments of this application.

In embodiments of this application, the target video frame and the reference video frame may be obtained from the inputted video, the joint point of the detected object is extracted separately from the target video frame and the reference video frame, and then after the detected rotation angle value configured for representing the joint point change magnitude of the joint point from the reference video frame to the target video frame is obtained, the virtual rotation magnitude configured for controlling the joint point change magnitude of the joint point within the preset magnitude range is determined based on a confidence range to which confidence of the joint point (that is, the target position confidence) belongs and the angle value range to which the detected rotation angle value of the joint point belongs. Then, the detected rotation angle value is adjusted based on the virtual rotation magnitude to obtain the adjusted rotation angle value. The adjusted rotation angle value may be configured for performing object driving on the virtual object in the reference virtual image associated with the reference video frame to obtain the virtual object in the target virtual image associated with the target video frame. Accordingly, when accuracy of the detected rotation angle value is not high, the detected rotation angle value with low accuracy may be adjusted based on the virtual rotation magnitude to obtain an adjusted rotation angle value with higher accuracy. In addition, the virtual rotation magnitude is configured for controlling the joint point change magnitude of the joint point within the preset magnitude range. Therefore, the virtual rotation magnitude can suppress large rotation of the joint point, and a current video frame (that is, the target video frame) may include a driving effect of a previous video frame (that is, the reference video frame) as much as possible by using the reference virtual image, so that a sudden change of the joint point in two adjacent frames is avoided (that is, avoiding an abnormal posture), thereby generating a more stable driving effect of the virtual object (that is, keeping timing smooth), and improving stability of the object driving of the virtual object.

### BRIEF DESCRIPTION OF THE DRAWINGS

To describe the technical solutions in embodiments of this application more clearly, the following briefly describes the accompanying drawings needed for describing embodiments or related art. Apparently, the accompanying drawings in the following description show merely some embodiments of this application, and a person of ordinary skill in the art may still derive other drawings from these accompanying drawings without creative efforts.

FIG. 1 is a schematic diagram of a structure of a network architecture according to an embodiment of this application.

FIG. 2 is a schematic diagram of a scenario of data exchange according to an embodiment of this application.

FIG. 3 is a schematic flowchart of a data processing method according to an embodiment of this application.

FIG. 4 is a schematic diagram of a scenario of obtaining a joint point according to an embodiment of this application.

FIG. 5a is a schematic diagram of a scenario of driving a virtual object according to an embodiment of this application.

FIG. 5b is a schematic diagram of a scenario of driving a virtual object according to an embodiment of this application.

FIG. 6 is a schematic flowchart of a data processing method according to an embodiment of this application.

FIG. 7 is a schematic flowchart of a data processing method according to an embodiment of this application.

FIG. 8 is a schematic flowchart of a data processing method according to an embodiment of this application.

FIG. 9 is a schematic diagram of a structure of a default detected object according to an embodiment of this application.

FIG. 10 is a schematic flowchart of driving a virtual object according to an embodiment of this application.

FIG. 11 is a schematic diagram of the structure of a data processing apparatus according to an embodiment of this application.

FIG. 12 is a schematic diagram of a structure of a computer device according to an embodiment of this application.

### DESCRIPTION OF EMBODIMENTS

The technical solutions in embodiments of this application are clearly and completely described below with reference to the accompanying drawings in embodiments of this application. Apparently, the described embodiments are merely some rather than all of embodiments of this application. All other embodiments obtained by a person of ordinary skill in the art based on embodiments of this application without making creative efforts shall fall within the protection scope of this application.

Artificial intelligence (AI) is a theory, a method, a technology, and an application system that use a digital computer or a machine controlled by the digital computer to simulate, extend, and expand human intelligence, perceive an environment, acquire knowledge, and use knowledge to obtain an optimal result. In other words, the artificial intelligence is a comprehensive technology in computer science and attempts to understand the essence of intelligence and produce a new intelligent machine that can react in a manner similar to human intelligence. The artificial intelligence is to study the design principles and implementation methods of various intelligent machines, to enable the machines to have the functions of perception, reasoning, and decision-making.

The artificial intelligence technology is a comprehensive discipline, and relates to a wide range of fields including both hardware-level technologies and software-level technologies. The basic artificial intelligence technologies generally include technologies such as a sensor, a dedicated artificial intelligence chip, cloud computing, distributed storage, a big data processing technology, an operating/interaction system, and electromechanical integration. An artificial intelligence software technology mainly includes some major directions such as a computer vision technology, a speech processing technology, a natural language processing technology, and machine learning/deep learning, automated driving, and smart transportation.

The solutions provided in embodiments of this application mainly relate to a computer vision (CV) technology and a machine learning (ML) technology of the artificial intelligence.

Computer vision is a science that studies how to use a machine to “see”, and furthermore, that uses a camera and a computer to replace human eyes to perform machine vision such as recognition and measurement on a target, and further perform graphic processing, so that the computer processes the target into an image more suitable for human eyes to observe, or an image transmitted to an instrument for detection. As a scientific discipline, the computer vision studies related theories and technologies and attempts to establish an artificial intelligence system that can obtain information from images or multidimensional data. The computer vision technology generally includes technologies such as image processing, image recognition, image semantic understanding, image retrieval, optical character recognition (OCR), video processing, video semantic understanding, video content/behavior recognition, three-dimensional object reconstruction, a 3D technology, virtual reality, augmented reality, synchronous positioning and map construction, autonomous driving, and smart transportation.

Machine learning is an interdisciplinary field, and relates to a plurality of disciplines such as the probability theory, statistics, approximation theory, convex analysis, and algorithm complexity theory. The machine learning specializes in studying how a computer simulates or implements a human learning behavior to obtain new knowledge or skills, and reorganize an existing knowledge structure, so as to keep improving its performance. The machine learning is the core of the artificial intelligence, is a basic way to make the computer intelligent, and is applied to various fields of the artificial intelligence. The machine learning and deep learning generally include technologies such as an artificial neural network, a belief network, reinforcement learning, transfer learning, inductive learning, and learning from demonstrations. A deep learning technology is a technology that uses deep neural network systems to perform the machine learning. The concept of the deep learning originates from the study of artificial neural networks. For example, a multilayer perceptron with a plurality of hidden layers is of a deep learning structure. In the deep learning, more abstract high-level representation attribute categories or features are formed by combining low-level features to find distributed feature representations of data.

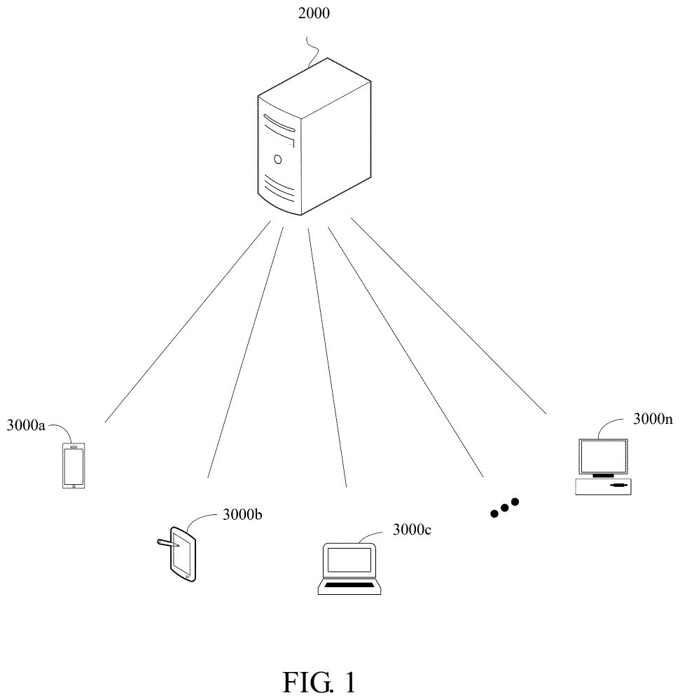

Specifically, FIG. 1 is a schematic diagram of the structure of a network architecture according to an embodiment of this application. As shown in FIG. 1, the network architecture may include a server 2000 and a terminal device cluster. The terminal device cluster may include one or more terminal devices. The quantity of terminal devices in the terminal device cluster herein is not limited thereto. As shown in FIG. 1, the plurality of terminal devices may include a terminal device 3000a, a terminal device 3000b, a terminal device 3000c, . . . , and a terminal device 3000n. The terminal device 3000a, the terminal device 3000b, the terminal device 3000c, . . . , and the terminal device 3000n may be in a direct or indirect network connection with the server 2000 in a wired or wireless communication manner, separately, so that each terminal device can exchange data with the server 2000 by using the network connection.

Each terminal device in the terminal device cluster may include: a smart terminal having a data processing function such as a smartphone, a tablet computer, a notebook computer, a desktop computer, an intelligent voice interaction device, a smart home appliance (for example, a smart television), a wearable device, an on-board terminal, an aircraft, or the like. An application client may be installed in each terminal device in the terminal device cluster shown in FIG. 1. When running in the terminal devices, the application clients may separately exchange data with the server 2000 shown in FIG. 1.

The application client may specifically include an on-board client, a smart home client, an entertainment client (for example, a game client), a multimedia client (for example, a video client), a social client, an information client (for example, a news client), and other clients with data processing functions. The application client in this embodiment may be integrated in a client (for example, the social client), and the application client may alternatively be an independent client (for example, the news client). A type of the application client is not limited in this embodiment.

The server 2000 shown in FIG. 1 may be a server corresponding to the application client. The server 2000 may be an independent physical server, or a server cluster or distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

For ease of understanding, in this embodiment, one terminal device may be selected from the plurality terminal devices shown in FIG. 1 as a target terminal device. For example, in this embodiment, the terminal device 3000a shown in FIG. 1 may be used as the target terminal device, and the application client with a data processing function may be installed in the target terminal device. In this case, the target terminal device may implement data exchange with the server 2000 through the application client.

A computer device in this embodiment may implement object driving for a virtual object in an inputted video by using cloud technology in the application client. Specifically, the computer device may obtain a target video frame and a reference video frame from the inputted video, determine, based on a joint point of a detected object from the target video frame and the joint point of the detected object from the reference video frame, a rotation angle value configured for representing a joint point change magnitude of the joint point from the reference video frame to the target video frame, and adjust the detected rotation angle value based on a virtual rotation magnitude configured for controlling the joint point change magnitude of the joint point within a preset magnitude range to obtain an adjusted rotation angle value corresponding to the joint point. The reference video frame may be used to generate an associated reference virtual image. The target video frame may be used to generate an associated target virtual image. Both the reference virtual image and the target virtual image may include a virtual object obtained through object simulation on the virtual object in the inputted video. The adjusted rotation angle value is configured for performing object driving on the virtual object in the reference virtual image to obtain the virtual object in the target virtual image.

In other words, this embodiment, a posture of each part of the detected object may be inferred from the inputted video, and the virtual object is driven based on the inferred posture. Because a quantity of parameters included in this embodiment is small, this embodiment is applicable to object driving of a virtual object on a mobile terminal, that is, real-time processing may be implemented through deployment on a mobile terminal in this embodiment.

The cloud technology is a hosting technology that integrates resources, such as hardware, software, and a network, to implement computing, storage, processing, and sharing of data in a wide area network or a local area network. The cloud technology is a general term of a network technology, an information technology, an integration technology, a management platform technology, and an application technology based on a cloud computing business model application, and may form a resource pool to satisfy what is needed in a flexible and convenient manner. The cloud computing technology is the backbone of many applications. A lot of computing resources and storage resources are needed for background services in a technical network system, such as a video website, a photo website, and more portal sites. With advanced development and application of the Internet technologies, all items are likely to have their own identification flag in the future. These flags need to be transmitted to a background system for logical processing. Data at different levels is to be processed separately. Therefore, data processing in all industries requires support of a powerful system, which can only be implemented through cloud computing.

The data processing method provided in an embodiment of this application may be performed by the server 2000 (that is, the computer device may be the server 2000), may be performed by the target terminal device (that is, the computer device may be the target terminal device), or may be performed jointly by the server 2000 and the target terminal device. For ease of understanding, in embodiments of this application, a user corresponding to the terminal device may be referred to as an object. For example, a user corresponding to the target terminal device may be referred to as a target object.

When the data processing method is jointly executed by the server 2000 and the target terminal device, the target terminal device may obtain a video used for object simulation and a virtual object selected by the target object, and send the video to the server 2000. Accordingly, the server 2000 may obtain the target video frame and the reference video frame from an inputted video after receiving the inputted video and the virtual object, then generate a target virtual image associated with the target video frame and a reference virtual image associated with the reference video frame based on the virtual object, the target video frame, and the reference video frame, and return the target virtual image and the reference virtual image to the target terminal device, so that the target terminal device continuously displays the reference virtual image and the target virtual image in the application client.

In one embodiment, when the data processing method is executed by the target terminal device, the target terminal device may obtain a video for object simulation, obtain a target video frame and a reference video frame from the video, then generate a target virtual image associated with the target video frame and a reference virtual image associated with the reference video frame based on the target video frame and the reference video frame, and continuously display the reference virtual image and the target virtual image in the application client.

In one embodiment, when the data processing method is executed by the server 2000, the server 2000 may obtain an inputted video for object simulation, obtain a target video frame and a reference video frame from the inputted video, then generate a target virtual image associated with the target video frame and a reference virtual image associated with the reference video frame based on the target video frame and the reference video frame, and return the target virtual image and the reference virtual image to the target terminal device, so that the target terminal device continuously displays the reference virtual image and the target virtual image in the application client.

The network architecture is used in a livestreaming scenario, a human-computer interaction scenario, and the like, and specific service scenarios are not listed one by one here. For example, in the livestreaming scenario, in this embodiment, the detected object in the inputted video may be simulated as a virtual object, and a livestreaming function is implemented based on the virtual object. To be specific, the virtual object is used for livestreaming instead of the detected object in a conventional livestreaming scenario. For another example, in the human-computer interaction scenario, in this embodiment, the detected object may be simulated in the inputted video as a virtual object, and a virtual image to which the virtual object belongs is recorded to obtain video data including the virtual object.

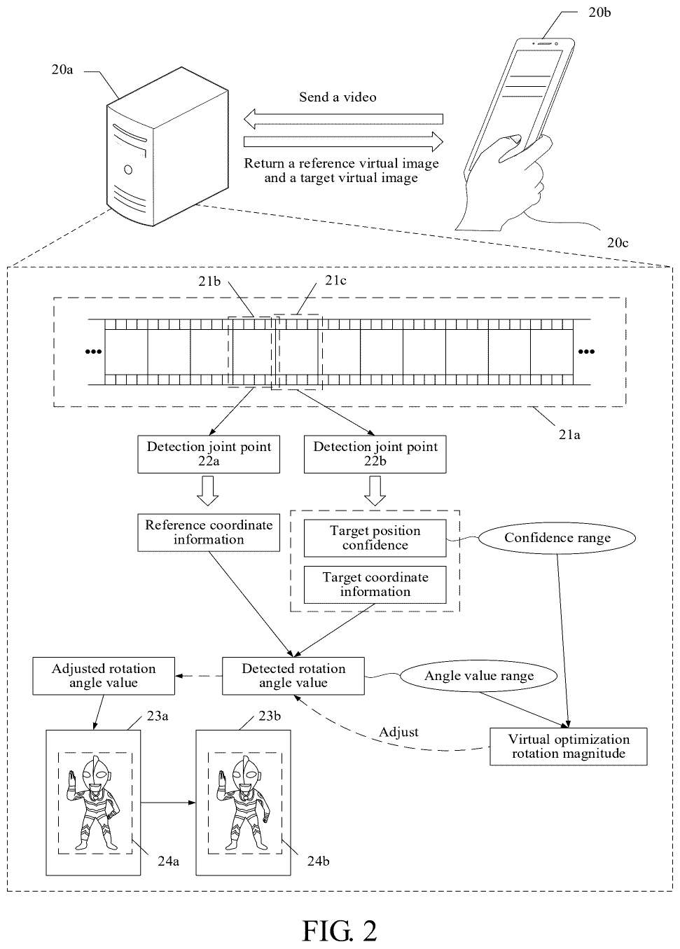

For ease of understanding, further, FIG. 2 is a schematic diagram of a scenario of data exchange according to an embodiment of this application. A server 20a shown in FIG. 2 may be the server 2000 in the embodiment corresponding to FIG. 1. A terminal device 20b shown in FIG. 2 may be the target terminal device in the embodiment corresponding to FIG. 1. An application client may be installed in the terminal device 20b. A user corresponding to the terminal device 20b may be an object 20c. For ease of understanding, an example in which the data processing method is performed by the server 20a is used for description in this embodiment.

As shown in FIG. 2, the object 20c may upload a video through the application client in the terminal device 20b, so that the terminal device 20b can send the video to the server 20a. The video may be recorded in real time by the object 20c through the application client in the terminal device 20b, or may be photographed in advance by the object 20c through the terminal device 20b, or may be downloaded from a network by the object 20c through the terminal device 20b. This is not limited in this application.

As shown in FIG. 2, the server 20a may receive the video (for example, a video 21a) sent by the terminal device 20b. The video 21a may include a plurality of video frames. For example, the plurality of video frames may include a video frame 21b and a video frame 21c. Further, the server 20a may obtain a target video frame (for example, the video frame 21c) and a reference video frame (for example, the video frame 21b) from the video. In the video 21a, the video frame 21b may be a previous video frame of the video frame 21c. The video 21a may be associated with a detected object (in other words, the video 21a may include the detected object), and both the target video frame (that is, the video frame 21c) and the reference video frame (that is, the video frame 21b) may include the detected object associated with the video 21a.

Further, as shown in FIG. 2, the server 20a may obtain a joint point of the detected object in the reference video frame (for example, a joint point 22a), and obtain a joint point of the detected object in the target video frame (for example, a joint point 22b). In this embodiment, it is assumed that the quantity of joint points 22a and the quantity of joint points 22b are the same, and the joint point 22a and the joint point 22b are the same. Further, the server 20a may obtain reference coordinate information of the joint point 22a in the reference video frame and target coordinate information of the joint point 22b in the target video frame. In this case, the server 20a may further obtain reference position confidence of the reference coordinate information of the joint point 22a in the reference video frame (that is, the reference position confidence of the joint point 22a in the reference video frame) and target position confidence of the target coordinate information of the joint point 22b in the target video frame (that is, the target position confidence of the joint point 22b in the target video frame).

Further, as shown in FIG. 2, the server 20a may generate, based on the reference coordinate information and the target coordinate information, a detected rotation angle value configured for representing a joint point change magnitude, and then determine, based on an angle value range to which the detected rotation angle value belongs and a confidence range to which the target position confidence belongs, a virtual rotation magnitude configured for controlling the joint point change magnitude of the joint point within a preset magnitude range. Further, the server 20a may adjust the detected rotation angle value based on the virtual rotation magnitude to obtain an adjusted rotation angle value (that is, an adjusted rotation angle value configured for representing the joint point change magnitude) between the joint point 22a and the joint point 22b.

The server 20a may perform object simulation on the detected object in the video 21a to obtain a virtual image (for example, a reference virtual image associated with the reference video frame, that is, a virtual image 23a) associated with a video frame in the video 21a. The virtual image 23a and the adjusted rotation angle value may be used to generate a virtual image 23b associated with the target video frame. Similarly, the server 20a may perform object simulation on the detected object in the video 21a to obtain a target virtual image associated with the target video frame in the video 21a, that is, the virtual image 23b.

As shown in FIG. 2, the server 20a may perform object driving on a virtual object 24a in the virtual image 23a by using the adjusted rotation angle value to obtain a virtual object 24b in the virtual image 23b. The virtual object 24a and the virtual object 24b are the same virtual object. A virtual image with the virtual object 24a may be the virtual image 23a, and a virtual image with the virtual object 24b may be the virtual image 23b.

The detected object and the virtual object in embodiments of this application may both be objects with action capabilities, specifically mag be objects with joint points and action capabilities. For example, the detected object may be a person, and the virtual object may be a cartoon character generated for the detected object.

Further, the server 20a may determine a next video frame of the video frame 21c as a new target video frame, determine the video frame 21c as a new reference video frame, and then generate a virtual image associated with the new target video frame, and so on, until the server 20a generates a virtual image associated with the last video frame in the video 21a. In this case, the server 20a is already generated virtual images associated with all video frames in the video 21a.

Further, as shown in FIG. 2, the server 20a may return the virtual images (including reference virtual images and target virtual images) associated with all video frames in the video 21a to the terminal device 20b, so that the terminal device 20b can display the virtual images (including reference virtual images and target virtual images) associated with the video frames in the video (that is, the video 21a) uploaded by the object 20c.

The terminal device 20b may display the virtual image associated with the video frame in the video alone, or may display the video frame in the video and the virtual image associated with the video frame in the video at the same time (that is, synchronously display the video frame in the video and the virtual image associated with the video frame in the video, for example, when displaying a video frame H in the video, the terminal device 20b displays a virtual image associated with the video frame H). This is not limited in this application.

In this embodiment, after the detected rotation angle value configured for representing the joint point change magnitude of the joint point is obtained, the virtual rotation magnitude of the joint point is determined based on the detected rotation angle value and the target position confidence, and then the detected rotation angle value is adjusted based on the virtual rotation magnitude to obtain the adjusted rotation angle value. When accuracy of the detected rotation angle value is not high, the detected rotation angle value with low accuracy is adjusted based on the virtual rotation magnitude to obtain an adjusted rotation angle value with higher accuracy. In addition, the virtual rotation magnitude is configured for controlling the joint point change magnitude within the preset magnitude range. Therefore, the virtual rotation magnitude can further suppress large rotation of the joint point and adjust the joint point change magnitude of the joint point, so that an adjusted rotation angle value with high accuracy and appropriate joint point change magnitude is obtained ultimately. Accordingly, when the object driving is performed on the virtual object based on the adjusted rotation angle value, stability of the object driving of the virtual object can be improved.

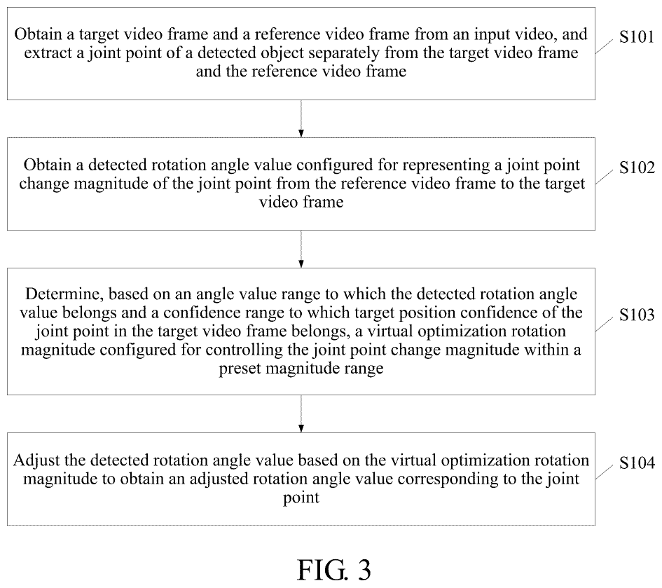

Further, FIG. 3 is a schematic flowchart of a data processing method according to an embodiment of this application. The method may be performed by a server, performed by a terminal device, or performed jointly by a server and a terminal device. The server may be the server 20a in the embodiment corresponding to FIG. 2. The terminal device may be the terminal device 20b in the embodiment corresponding to FIG. 2. The data processing method may include the following operation S101 to operation S104.

Operation S101: Obtain a target video frame and a reference video frame from an inputted video, and extract a joint point of a detected object separately from the target video frame and the reference video frame.

Specifically, the target video frame may be any video frame in the input video. The target video frame is obtained from the inputted video, and a previous video frame of the target video frame is obtained from the input video if the target video frame is not the first video frame of the inputted video. The previous video frame of the target video frame is determined as the reference video frame. In other words, the reference video frame is the previous video frame of the target video frame. Further, the target video frame is inputted into a posture estimation model, posture estimation is performed on the target video frame by using the posture estimation model, and the joint point of the detected object in the target video frame is outputted. The reference video frame is inputted into the posture estimation model, posture estimation is performed on the reference video frame by using the posture estimation model, and the joint point of the detected object in the reference video frame is outputted. There may be one or more joint points of the detected object in the target video frame, and there may be one or more joint points of the detected object in the reference video frame.

In this embodiment, whether a cache variable last_frame is empty may be determined. If the cache variable last_frame is empty, it is determined that the target video frame is the first video frame in the input video. In one embodiment, if the cache variable last_frame is not empty, it is determined that the target video frame is not the first video frame in the input video. The cache variable last_frame may be configured for storing a video frame in the input video. Specifically, the cache variable last_frame may be configured for storing a previous video frame of the target video frame (that is, the reference video frame). The reference video frame is relative to the target video frame, and different target video frames may correspond to different reference video frames.

The posture estimation model (that is, a human posture model) is generated through iterative training on an initial posture estimation model. A 3D human data set used in the iterative training may enable the posture estimation model to output the joint point of the detected object. In one embodiment, when the posture estimation model is applied to a mobile terminal, the posture estimation model may be a neural network with a small quantity of parameters. A model type of the posture estimation model is not limited in this embodiment.

The inputted video may include a detected object. Accordingly, both the target video frame and the reference video frame may include a detected object. The detected object in the target video frame and the detected object in the reference video frame may be the same detected object, and the detected object may have different actions in the target video frame and in the reference video frame. A quantity of joint points of the detected object in the target video frame outputted by the posture estimation model may be S₁, and S joint points of the detected object in the target video frame may be generated based on the S₁ joint points. Similarly, a quantity of joint points of the detected object in the reference video frame outputted by the posture estimation model may be S₂, and S joint points of the detected object in the reference video frame may be generated based on the S₂ joint points. S here may be a positive integer greater than 1. S₁ here may be a positive integer less than or equal to S. S₂ here may be a positive integer less than or equal to S. Therefore, the quantity of joint points of the detected object in the target video frame and the quantity of joint points of the detected object in the reference video frame are the same. The quantity of joint points is S.

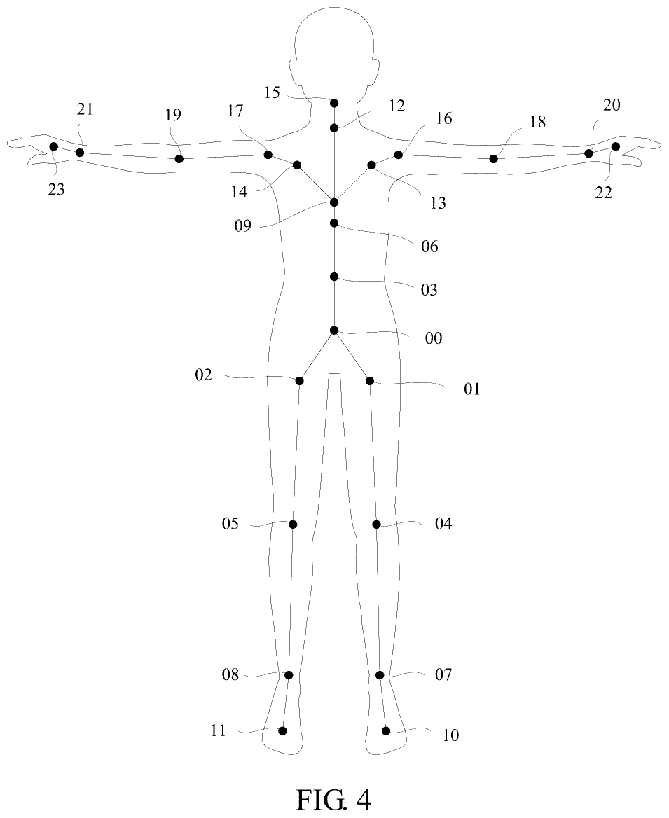

For ease of understanding, FIG. 4 is a schematic diagram of a scenario of obtaining a joint point according to an embodiment of this application. The detected object in the inputted video is shown in FIG. 4. An example in which the action of the detected object is the action shown in FIG. 4 is used for description. The detected object shown in FIG. 4 may include S joint points. S here may be a positive integer greater than 1. An example in which S is 24 is used here for description.

As shown in FIG. 4, the S joint points of the detected object may specifically include a joint point 00, a joint point 01, a joint point 02, a joint point 03, a joint point 04, a joint point 05, a joint point 06, a joint point 07, a joint point 08, a joint point 09, a joint point 10, a joint point 11, a joint point 12, a joint point 13, a joint point 14, a joint point 15, a joint point 16, a joint point 17, a joint point 18, a joint point 19, a joint point 20, a joint point 21, a joint point 22, and a joint point 23.

Different joint points correspond to different part areas. For example, a part area of the detected object may include a trunk area and a non-trunk area (that is, a four-limb area). The joint point 00, the joint point 03, the joint point 06, the joint point 09, the joint point 12, the joint point 13, the joint point 14, and the joint point 15 may belong to the trunk area. The joint point 01, the joint point 02, the joint point 04, the joint point 05, the joint point 07, the joint point 08, the joint point 10, the joint point 11, the joint point 16, the joint point 17, the joint point 18, the joint point 19, the joint point 20, the joint point 21, the joint point 22, and the joint point 23 may belong to the non-trunk area.

Similarly, different joint points correspond to different joint point types. A joint point type of the detected object may include a joint point type corresponding to a root joint point and a joint point type corresponding to a non-root joint point. The joint point 00 may be the root joint point (to be specific, a joint point type of the joint point 00 may be the joint point type corresponding to the root joint point). The joint point 02, the joint point 03, the joint point 04, the joint point 05, the joint point 06, the joint point 07, the joint point 08, the joint point 09, the joint point 10, the joint point 11, the joint point 12, the joint point 13, the joint point 14, the joint point 15, the joint point 16, the joint point 17, the joint point 18, the joint point 19, the joint point 20, the joint point 21, the joint point 22, and the joint point 23 may be non-root joint points.

Operation S102: Obtain a detected rotation angle value configured for representing a joint point change magnitude of the joint point from the reference video frame to the target video frame.

Target coordinate information of the joint point in the target video frame may be outputted by using the posture estimation model. Reference coordinate information of the joint point in the reference video frame may be outputted by using the posture estimation model. Therefore, a specific process of obtaining a detected rotation angle value configured for representing a joint point change magnitude of the joint point from the reference video frame to the target video frame may be described as: generating, based on the target coordinate information of the joint point in the target video frame and the reference coordinate information of the joint point in the reference video frame, the detected rotation angle value configured for representing the joint point change magnitude of the joint point.

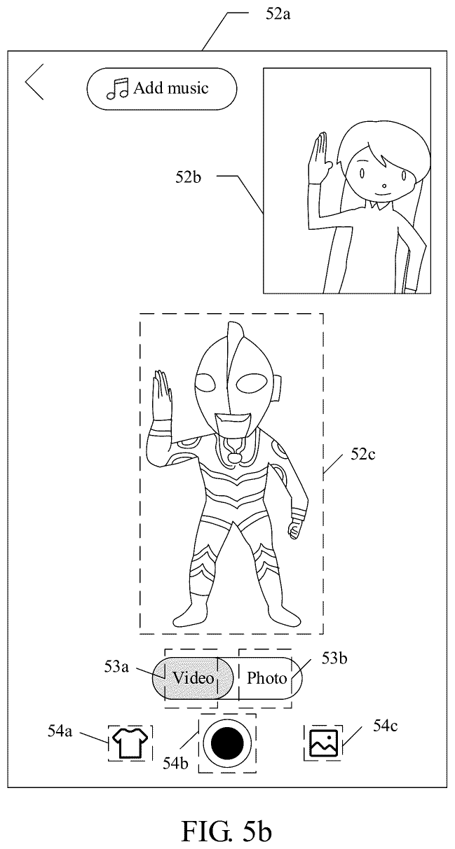

For a specific process of generating, based on the target coordinate information of the joint point in the target video frame and the reference coordinate information of the joint point in the reference video frame, the detected rotation angle value configured for representing the joint point change magnitude of the joint point, reference may be made to the following descriptions of operation S1021 to operation S1024 in the embodiment corresponding to FIG. 6.

In addition, target position confidence is confidence of the target coordinate information of the joint point in the target video frame outputted by using the posture estimation model. In other words, the target position confidence of the target coordinate information of the joint point in the target video frame may be outputted by using the posture estimation model. Similarly, reference position confidence is confidence of the reference coordinate information of the joint point in the reference video frame outputted by using the posture estimation model. In other words, the reference position confidence of the reference coordinate information of the joint point in the reference video frame may be outputted by using the posture estimation model.

The target position confidence may be configured for indicating accuracy of the target coordinate information (to be specific, indicating whether the target coordinate information is trusted). The reference position confidence may be configured for indicating accuracy of the reference coordinate information (to be specific, indicating whether the reference coordinate information is trusted). A value range of the target position confidence may be 0 to 1. A value range of the reference position confidence may be 0 to 1. A larger confidence value indicates more trusted coordinate information.

Operation S103: Determine, based on an angle value range to which the detected rotation angle value belongs and a confidence range to which target position confidence of the joint point in the target video frame belongs, a virtual rotation magnitude configured for controlling the joint point change magnitude within a preset magnitude range.

Specifically, an angle value rotation magnitude corresponding to the joint point may be determined based on the angle value range to which the detected rotation angle value belongs. A confidence rotation magnitude corresponding to the joint point may be determined based on the confidence range to which the target position confidence of the joint point in the target video frame belongs. Further, the virtual rotation magnitude configured for controlling the joint point change magnitude of the joint point within the preset magnitude range may be generated by performing multiplication operation on the angle value rotation magnitude and the confidence rotation magnitude. The joint point change magnitude may be a joint point rotation magnitude. When the joint point change magnitude is a joint point rotation magnitude, the virtual rotation magnitude is configured for controlling the joint point rotation magnitude within the preset magnitude range. In one embodiment, the angle value range to which the detected rotation angle value belongs may be a preset angle value range. For example, the preset angle value range is a to b, a may be a value between 0 and 360 degrees, and b may also be a value between 0 and 360 degrees. The confidence range to which the target position confidence belongs may be 0 to 1.

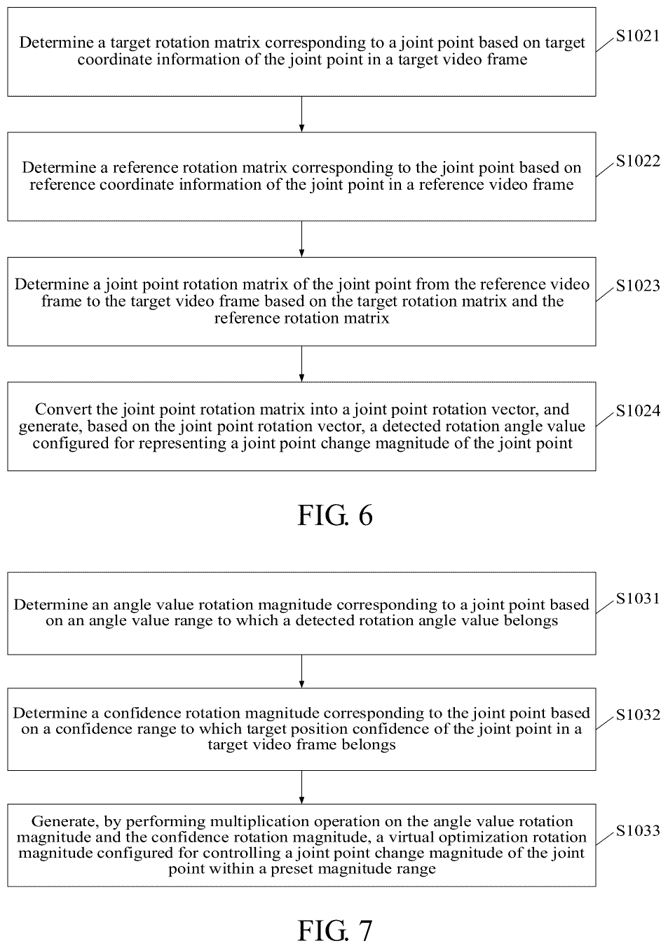

For a specific process of determining the angle value rotation magnitude corresponding to the joint point based on the angle value range to which the detected rotation angle value belongs, reference may be made to the following descriptions of operation S1031 in the embodiment corresponding to FIG. 7. For a specific process of determining the confidence rotation magnitude corresponding to the joint point based on the confidence range to which the target position confidence of the joint point in the target video frame belongs, reference may be made to the following descriptions of operation S1032 in the embodiment corresponding to FIG. 7. For a specific process of generating, by performing multiplication operation on the angle value rotation magnitude and the confidence rotation magnitude, the virtual rotation magnitude configured for controlling the joint point change magnitude of the joint point within the preset magnitude range, reference may be made to the following descriptions of operation S1033 in the embodiment corresponding to FIG. 7.

Operation S104: Adjust the detected rotation angle value based on the virtual rotation magnitude to obtain an adjusted rotation angle value corresponding to the joint point.

Specifically, the adjusted rotation angle value corresponding to the joint point, that is, the adjusted rotation angle value configured for representing the joint point change magnitude of the joint point from the reference video frame to the target video frame, is generated by performing multiplication operation on the virtual rotation magnitude and the detected rotation angle value. The adjusted rotation angle value is configured for performing object driving on a virtual object in a reference virtual image associated with the reference video frame to obtain a virtual object in a target virtual image associated with the target video frame. The object driving herein is driving of the virtual object to perform actions, postures, and the like. The virtual object in the reference virtual image is obtained by performing object simulation on the detected object in the reference video frame. The virtual object in the target virtual image is obtained by performing object simulation on the detected object in the target video frame.

A quantity of joint points is S, S herein is a positive integer greater than 1, and S joint points include a target joint point. The detected rotation angle value configured for representing the joint point change magnitude of the target joint point may be adjusted based on the virtual rotation magnitude configured for controlling the joint point change magnitude of the joint point within the preset magnitude range to obtain the adjusted rotation angle value corresponding to the target joint point.

For example, the virtual rotation magnitude configured for controlling the joint point change magnitude of the joint point within the preset magnitude range may be w, and the detected rotation angle value configured for representing the joint point change magnitude of the target joint point may be Q. Therefore, the adjusted rotation angle value corresponding to the target joint point may be Q_post, and the adjusted rotation angle value Q_post may be represented as Q_post=w*Q.

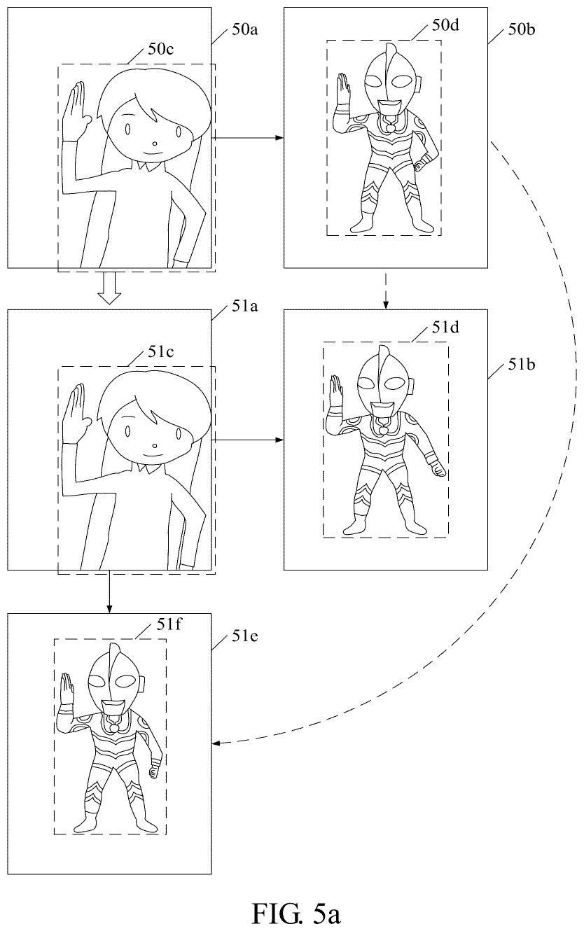

For ease of understanding, FIG. 5a is a schematic diagram of a scenario of driving a virtual object according to an embodiment of this application. A video frame 50a and a video frame 51a shown in FIG. 5a may be two consecutive video frames in an inputted video. The video frame 50a may be a reference video frame, and the video frame 51a may be a target video frame. In other words, the video frame 50a may be a previous video frame of the video frame 51a. The video frame 50a and the video frame 51a each may include a detected object. The detected object in the video frame 50a may be a detected object 50c, and the detected object in the video frame 51a may be a detected object 51c.

As shown in FIG. 5a, in this embodiment, a virtual image 50b (that is, a reference virtual image) associated with the video frame 50a may be obtained, and the virtual image 50b may include a virtual object 50d obtained by performing object simulation on the detected object 50c. A left elbow point of the detected object 50c is detected correctly, and data is normal. In this case, the driven virtual object 50d is reasonable.

Because the video frame 51a is a next video frame of the video frame 50a, by performing object driving on the virtual object 50d in the virtual image 50b associated with the video frame 50a, a virtual object (that is, a virtual object obtained by performing object simulation on the detected object 51c) associated with the detected object 51c in the video frame 51a may be obtained. If the object driving is performed on the virtual object 50d in the virtual image 50b associated with the video frame 50a based on a detected rotation angle value, a virtual object 51d (that is, the virtual object 51d in a virtual image 51b) associated with the detected object 51c may be generated. In one embodiment, if the object driving is performed on the virtual object 50d in the virtual image 50b associated with the video frame 50a based on an adjusted rotation angle value, a virtual object 51f (that is, the virtual object 51f in a virtual image 51e) associated with the detected object 51c may be generated. The virtual image 51e (that is, a target virtual image) may be a virtual image associated with the video frame 51a.

The left elbow of the detected object 51c is out of the frame, resulting in an abnormal detection result of a left elbow point of the detected object 51c. Elbow driving of the virtual object 51d in the virtual image 51b is abnormal. Consequently, postures of the virtual object 51d and the detected object 51c differ significantly, in other words, the left elbow of the virtual object 51d suddenly changes a lot compared with the virtual object 50d. Considering that an elbow will not rotate very much in a very short period of time, and confidence of the joint point of the left elbow is low, the virtual object 51f of the virtual image 51e controls a rotation magnitude of the video frame 51a compared to the video frame 50a (that is, a virtual rotation magnitude). Compared with the virtual object 51d, the virtual object 51f is more consistent with the detected object 51c in posture, thereby achieving an objective of more stable object driving of the virtual object.

For ease of understanding, FIG. 5b is a schematic diagram of a scenario of driving a virtual object according to an embodiment of this application. FIG. 5b shows an application interface 52a displayed by an application client. A virtual image (for example, a target virtual image) may be displayed in the application interface 52a. The target virtual image may include a virtual object 52c. In this case, a video frame (for example, a target video frame 52b) may be displayed in the application interface 52a, and the target video frame 52b may include a detected object.

As shown in FIG. 5b, the application interface 52a may further include a switching control 53a (that is, a video switching control 53a) and a switching control 53b (that is, an image switching control 53b). Video data may be captured in the application interface 52a by using the switching control 53a, and image data may be captured in the application interface 52a by using the switching control 53b. When the switching control 53a is in a selected state, and the switching control 53b is in a non-selected state, video data captured in the application interface 52a is displayed. In one embodiment, when the switching control 53b is in a selected state, and the switching control 53a is in a non-selected state, image data captured in the application interface 52a is displayed.

As shown in FIG. 5b, the application interface 52a may further include a change control 54a, a photographing control 54b, and a file selection control 54c. The change control 54a may be used to change the virtual object displayed in the application interface 52a, or the change control 54a may be used to change clothing worn by the virtual object displayed in the application interface 52a. In one embodiment, the virtual object may alternatively be an object obtained from a virtual object database through object recognition on the detected object. Photographing may be performed in the application interface 52a by using the photographing control 54b, then video data or image data is generated based on selection states of the switching control 53a and the switching control 53b. The video data or image data is obtained by capturing the virtual image displayed in the application interface 52a. The file selection control 54c may be used to upload recorded video data (that is, an inputted video) or recorded image data. The recorded video data or recorded image data may be configured for indicating the application client to perform object simulation on a detected object in the recorded video data or recorded image data, to generate a virtual image associated with a video frame in the recorded video data or a virtual image associated with the recorded image data. The recorded image data may be considered as the first video frame.

In this embodiment, the target video frame and the reference video frame may be obtained from the inputted video, the joint point of the detected object is extracted separately from the target video frame and the reference video frame, and then after the detected rotation angle value configured for representing the joint point change magnitude of the joint point from the reference video frame to the target video frame is obtained, the virtual rotation magnitude configured for controlling the joint point change magnitude of the joint point within the preset magnitude range is determined based on a confidence range to which confidence of the joint point (that is, the target position confidence) belongs and the angle value range to which the detected rotation angle value of the joint point belongs. Then, the detected rotation angle value is adjusted based on the virtual rotation magnitude to obtain the adjusted rotation angle value. The adjusted rotation angle value may be configured for performing object driving on the virtual object in the reference virtual image associated with the reference video frame to obtain the virtual object in the target virtual image associated with the target video frame. Accordingly, when accuracy of the detected rotation angle value is not high, the detected rotation angle value with low accuracy may be adjusted based on the virtual rotation magnitude to obtain an adjusted rotation angle value with higher accuracy. In addition, the virtual rotation magnitude is configured for controlling the joint point change magnitude of the joint point within the preset magnitude range. Therefore, the virtual rotation magnitude can suppress large rotation of the joint point, and a current video frame (that is, the target video frame) may include a driving effect of a previous video frame (that is, the reference video frame) as much as possible by using the reference virtual image, so that a sudden change of the joint point in two adjacent frames is avoided (that is, avoiding an abnormal posture), thereby generating a more stable driving effect of the virtual object (that is, keeping timing smooth), and improving stability of the object driving of the virtual object.

Further, FIG. 6 is a schematic flowchart of a data processing method according to an embodiment of this application. The data processing method may include the following operation S1021 to operation S1024, and operation S1021 to operation S1024 are a specific embodiment of operation S102 in the embodiment corresponding to FIG. 3. A quantity of joint points is S, S herein is a positive integer greater than 1, and S joint points include a target joint point.

Operation S1021: Determine a target rotation matrix corresponding to the joint point based on the target coordinate information of the joint point in the target video frame.

Specifically, a target joint point type corresponding to the target joint point is obtained. Further, a sub-joint point of the target joint point is obtained from the S joint points if the target joint point type is a joint point type corresponding to a root joint point, and a target rotation matrix corresponding to the target joint point is determined based on target coordinate information of the target joint point in the target video frame and target coordinate information of the sub-joint point in the target video frame. In one embodiment, a parent joint point of the target joint point is obtained from the S joint points if the target joint point type is a joint point type corresponding to a non-root joint point, and a target rotation matrix corresponding to the target joint point is determined based on target coordinate information of the target joint point in the target video frame and target coordinate information of the parent joint point in the target video frame.

When the target joint point type is the joint point type corresponding to the root joint point, the target joint point is the joint point 00 in the embodiment corresponding to FIG. 4. A quantity of sub-joint points of the target joint point may be one or more. The quantity of sub-joint points of the target joint point is not limited in this embodiment. Similarly, a quantity of sub-joint points used in the target rotation matrix corresponding to the determined target joint point is not limited in this embodiment. A sub-joint point of the joint point 00 may include the joint point 01 (that is, a sub-joint point 01), the joint point 02 (that is, a sub-joint point 02), and the joint point 03 (that is, a sub-joint point 03). For example, the target rotation matrix corresponding to the target joint point may be determined based on the target coordinate information of the target joint point in the target video frame, target coordinate information of the sub-joint point 01 in the target video frame, and target coordinate information of the sub-joint point 02 in the target video frame. For another example, the target rotation matrix corresponding to the target joint point may be determined based on the target coordinate information of the target joint point in the target video frame, target coordinate information of the sub-joint point 01 in the target video frame, and target coordinate information of the sub-joint point 03 in the target video frame.

Similarly, when the target joint point type is the joint point type corresponding to the non-root joint point, the target joint point may be any joint point in the embodiment corresponding to FIG. 4 other than the joint point 00, for example, the joint point 01. A quantity of parent joint points of the target joint point may be one. For example, a parent joint point of the joint point 01 may be the joint point 00 (that is, a parent joint point 00).

Operation S1022: Determine a reference rotation matrix corresponding to the joint point based on the reference coordinate information of the joint point in the reference video frame.

Specifically, a target joint point type corresponding to the target joint point is obtained. Further, a sub-joint point of the target joint point is obtained from the S joint points if the target joint point type is a joint point type corresponding to a root joint point, and a reference rotation matrix corresponding to the target joint point is determined based on reference coordinate information of the target joint point in the reference video frame and reference coordinate information of the sub-joint point in the reference video frame. In one embodiment, a parent joint point of the target joint point is obtained from the S joint points if the target joint point type is a joint point type corresponding to a non-root joint point, and the reference rotation matrix corresponding to the target joint point is determined based on reference coordinate information of the target joint point in the reference video frame and reference coordinate information of the parent joint point in the reference video frame.

Operation S1023: Determine a joint point rotation matrix of the joint point from the reference video frame to the target video frame based on the target rotation matrix and the reference rotation matrix.

Specifically, inverse transformation is performed on the reference rotation matrix to obtain an inverse reference rotation matrix of the reference rotation matrix. Further, matrix multiplication is performed on the inverse reference rotation matrix and the target rotation matrix to obtain the joint point rotation matrix of the joint point from the reference video frame to the target video frame.

The target rotation matrix is for one joint point (for example, the target joint point), and the reference rotation matrix is for one joint point (for example, the target joint point). The joint point rotation matrix of the target joint point from the reference video frame to the target video frame may be determined based on the target rotation matrix corresponding to the target joint point and the reference rotation matrix corresponding to the target joint point.

For example, the target rotation matrix corresponding to the target joint point may be M_cur, and the reference rotation matrix corresponding to the target joint point may be M_last. Therefore, the joint point rotation matrix of the target joint point from the reference video frame to the target video frame may be M_R (that is, a rotation matrix M_R of the target joint point from the reference video frame to the target video frame). The rotation matrix M_R may be represented as M_R=M_last_inv*M_cur. M_last_inv is an inverse matrix of M_last.

For a specific process of obtaining a target rotation matrix corresponding to a joint point in the S joint points other than the target joint point, reference may be made to descriptions of obtaining the target rotation matrix corresponding to the target joint point. Details are not described herein again. Similarly, for a specific process of obtaining a reference rotation matrix corresponding to a joint point in the S joint points other than the target joint point, reference may be made to descriptions of obtaining the reference rotation matrix corresponding to the target joint point. Details are not described herein again. Similarly, for a specific process of obtaining a joint point rotation matrix of a joint point in the S joint points other than the target joint point from the reference video frame to the target video frame, reference may be made to descriptions of obtaining the joint point rotation matrix of the target joint point from the reference video frame to target video frame. Details are not described herein again.

Operation S1024: Convert the joint point rotation matrix into a joint point rotation vector, and generate, based on the joint point rotation vector, the detected rotation angle value configured for representing the joint point change magnitude of the joint point.

Specifically, the joint point rotation matrix of the target joint point from the reference video frame to the target video frame is converted into a joint point rotation vector corresponding to the target joint point, and the detected rotation angle value configured for representing the joint point change magnitude of the target joint point may be generated based on the joint point rotation vector corresponding to the target joint point.

Therefore, in this embodiment, rotation information (that is, the detected rotation angle value configured for representing the joint point change magnitude of the joint point) corresponding to each joint point (that is, the joint point) through human body forward kinematics and inverse kinematics. For example, in this embodiment, the joint point rotation matrix (for example, the rotation matrix M_R) may be converted into the joint point rotation vector (for example, the rotation vector V_R) based on the Rodrigues' formula, so that the detected rotation angle value configured for representing the joint point change magnitude of the joint point is generated based on the joint point rotation vector, to be specific, a modulus of the joint point rotation vector is determined as the detected rotation angle value configured for representing the joint point change magnitude of the joint point.

In this embodiment, the target rotation matrix corresponding to the joint point may be determined based on the target coordinate information of the joint point in the target video frame, and the reference rotation matrix corresponding to the joint point may be determined based on the reference coordinate information of the joint point in the reference video frame. Then, the detected rotation angle value configured for representing the joint point change magnitude of the joint point is generated based on the target rotation matrix and the reference rotation matrix. Therefore, in this embodiment, the detected rotation angle value configured for representing the joint point change magnitude of the joint point is determined based on the target coordinate information and the reference coordinate information, so that accuracy of the obtained detected rotation angle value is improved.

Further, FIG. 7 is a schematic flowchart of a data processing method according to an embodiment of this application. The data processing method may include the following operation S1031 to operation S1033, and operation S1031 to operation S1033 are a specific embodiment of operation S103 in the embodiment corresponding to FIG. 3.

Operation S1031: Determine an angle value rotation magnitude corresponding to the joint point based on the angle value range to which the detected rotation angle value belongs.

Specifically, an angle value range parameter corresponding to the angle value range to which the detected rotation angle value belongs is obtained, and a part area corresponding to the joint point is obtained. Further, the angle value range parameter is determined as the angle value rotation magnitude corresponding to the joint point if the part area belongs to a trunk area (for example, a neck point and a hip joint point). In one embodiment, expansion processing is performed, if the part area belongs to a non-trunk area (for example, an elbow point and a leg), on the angle value range parameter to obtain an angle value expansion parameter, and a larger value of the angle value expansion parameter and a preset parameter is determined as the angle value rotation magnitude corresponding to the joint point. A specific value of the preset parameter is not limited in this embodiment. For example, the preset parameter may be equal to 1, and the preset parameter may be configured for controlling a value of the angle value rotation magnitude that does not exceed the preset parameter. A value range of the angle value rotation magnitude may be 0 to 1.

Change magnitudes of the trunk area and the non-trunk area (for example, a four-limb area) are different. The non-trunk area often has a larger change magnitude and more diverse change postures than the trunk area. Therefore, different strategies need to be used for joint points of the trunk area and the non-trunk area to control angle value rotation magnitudes of the joint points.

Expansion processing may be performed on the angle value range parameter based on an expansion coefficient to obtain the angle value expansion parameter. In other words, the angle value expansion parameter may be generated by performing multiplication operation on the expansion coefficient and the angle value range parameter.

A quantity and a range of divisions of the angle value range are not limited in this embodiment. For example, the quantity of divisions of the angle value range may be 4, and the angle value range may include a first angle value range, a second angle value range, a third angle value range, and a fourth angle value range. The range of divisions of the first angle value range, the second angle value range, the third angle value range, and the fourth angle value range may be 0 degrees to 360 degrees.

An angle value range parameter corresponding to the first angle value range may be a first angle value range parameter, an angle value range parameter corresponding to the second angle value range may be a second angle value range parameter, an angle value range parameter corresponding to the third angle value range may be a third angle value range parameter, and an angle value range parameter corresponding to the fourth angle value range may be a fourth angle value range parameter. Similarly, an angle value expansion parameter corresponding to the first angle value range may be a first angle value expansion parameter, an angle value expansion parameter corresponding to the second angle value range may be a second angle value expansion parameter, an angle value expansion parameter corresponding to the third angle value range may be a third angle value expansion parameter, and an angle value expansion parameter corresponding to the fourth angle value range may be a fourth angle value expansion parameter.

For a specific process of determining an angle value rotation magnitude corresponding to a joint point of the trunk area in this embodiment, reference may be made to the following formula (1).

$${w}_{1} = \{ \begin{matrix}{L}_{1} & 0 \leq x \leq 25 \\ {L}_{2} & 25 < x \leq 45 \\ {L}_{3} & 45 < x \leq 90 \\ {L}_{4} & 90 < x \leq 360\end{matrix} \qquad ( 1 )$$

In the formula (1), L₁, L₂, L₃, and L₄ may indicate a magnitude coefficient (that is, the angle value range parameter), and 0≤x≤25, 25<x≤45, 45<x≤90, and 90<x≤360 may indicate an angle value range. For example, L₁ may indicate the first angle value range parameter, and 0≤x≤25 may indicate the first angle value range. L₂ may indicate the second angle value range parameter, and 25≤x≤45 may indicate the second angle value range. L₃ may indicate the third angle value range parameter, and 45≤x≤90 may indicate the third angle value range. L₄ may indicate the fourth angle value range parameter, and 90≤x≤360 may indicate the fourth angle value range. x may indicate the detected rotation angle value, and a value range of x is 0 degrees to 360 degrees (that is, [0,360]). Each value range of L₁, L₂, L₃, and L₄ is 0 to 1, and L₁>L₂>L₃>L₄. w₁ may indicate the angle value rotation magnitude.

For a specific process of determining an angle value rotation magnitude corresponding to a joint point of the non-trunk area in this embodiment, reference may be made to the following formula (2).

$${w}_{1} = \{ \begin{matrix}a * {L}_{1} & 0 \leq x \leq 25 \\ a * {L}_{2} & 25 < x \leq 45 \\ a * {L}_{3} & 45 < x \leq 90 \\ a * {L}_{4} & 90 < x \leq 360\end{matrix} \qquad ( 2 )$$

In the formula (2), a*L₁, a*L₂, a*L₃, and a*L₄ may indicate a magnitude coefficient (that is, the angle value expansion parameter), and 0≤x≤25, 25<x≤45, 45<x≤90, and 90<x≤360 may indicate an angle value range. For example, a*L₁, may indicate the first angle value expansion parameter, and 0≤x≤25 may indicate the first angle value range. a*L₂ may indicate the second angle value expansion parameter, and 25<x≤45 may indicate the second angle value range. a*L₃ may indicate the third angle value expansion parameter, and 45<x≤90 may indicate the third angle value range. a*L₄ may indicate the fourth angle value expansion parameter, and 90<x≤360 may indicate the fourth angle value range. x may indicate the detected rotation angle value, and a value range of x is 0 degrees to 360 degrees (that is, [0,360]). Each value range of L₁, L₂, L₃, and L₄ is 0 to 1, and L₁>L₂>L₃>L₄. a may indicate an expansion coefficient used in the expansion processing, and a≤1.0. Therefore, a*L₁>a*L₂>a*L₃>a*L₄, and w₁ may indicate the angle value expansion parameter.

For a specific process of determining a larger value of the angle value expansion parameter and the preset parameter as the angle value rotation magnitude corresponding to the joint point in this embodiment, reference may be made to the following formula (3).

$${w}_{1} = max ( {w}_{1} , 1 ) \qquad ( 3 )$$

w₁ at the left side of formula (3) may indicate the angle value rotation magnitude, and w₁ at the right side of formula (3) may indicate the angle value expansion parameter, 1 may indicate the preset parameter, and max (w₁,1) may indicate the larger value of the obtained angle value expansion parameter and the preset parameter.

Operation S1032: Determine a confidence rotation magnitude corresponding to the joint point based on the confidence range to which the target position confidence of the joint point in the target video frame belongs.

Specifically, a first confidence range parameter corresponding to a first confidence range is determined as the confidence rotation magnitude corresponding to the joint point if the confidence range to which the target position confidence of the joint point in the target video frame belongs is the first confidence range. In one embodiment, operation processing is performed, if the confidence range to which the target position confidence of the joint point in the target video frame belongs is a second confidence range, on the target position confidence to obtain a second confidence range parameter corresponding to the second confidence range, and the second confidence range parameter is determined as the confidence rotation magnitude corresponding to the joint point. A value range of the confidence rotation magnitude may be 0 to 1.

In one embodiment, the first confidence range may include a first confidence sub-range and a second confidence sub-range. The first confidence sub-range and the second confidence sub-range may correspond to different confidence range parameters. A first confidence sub-range parameter corresponding to the first confidence sub-range is determined as the confidence rotation magnitude corresponding to the joint point if the confidence range to which the target position confidence of the joint point in the target video frame belongs is the first confidence sub-range. In one embodiment, a second confidence sub-range parameter corresponding to the second confidence sub-range is determined as the confidence rotation magnitude corresponding to the joint point if the confidence range to which the target position confidence of the joint point in the target video frame belongs is the second confidence sub-range.

For a specific process of determining the confidence rotation magnitude corresponding to the joint point in the embodiment of this application, reference may be made to the following formula (4).

$${w}_{2} = \{ \begin{matrix}0.1 & 0 \leq x \leq 0.2 \\ \frac{1}{1 + {e}^{- x}} & 0.2 < x \leq 0.8 \\ 1 & 0.8 < x \leq 1\end{matrix} \qquad ( 4 )$$

In formula (4), 0≤x≤0.2 may indicate the first confidence sub-range, and 0.1 may indicate the first confidence sub-range parameter corresponding to the first confidence sub-range. 0.8<x≤1 may indicate the second confidence sub-range, and 1 may indicate the second confidence sub-range parameter corresponding to the second confidence sub-range. 0.2<x≤0.8 may indicate the second confidence range, and

$$\frac{1}{1 + {e}^{- x}}$$

may indicate the second confidence range parameter corresponding to the second confidence range. x may indicate the target position confidence, and a value range of x may be 0 to 1 (that is, [0,1]). w₂ may indicate the confidence rotation magnitude.

A specific process of performing operation processing on the target position confidence to obtain a second confidence range parameter corresponding to the second confidence range may be described as: Opposite position confidence (that is, −x) corresponding to the target position confidence may be generated by performing negation processing on the target position confidence (that is, x) Further, index position confidence (that is, e^{-x}) corresponding to the opposite position confidence may be generated by performing index processing on the opposite position confidence. Further, a candidate parameter (that is, 1+e^{-x}) may be generated by performing summation operation on the index position confidence and the preset parameter (for example, 1). Further, the second confidence range parameter corresponding to the second confidence range may be generated by performing multiplicative inverse processing on the candidate parameter.

Operation S1033: Generate, by performing multiplication operation on the angle value rotation magnitude and the confidence rotation magnitude, the virtual rotation magnitude configured for controlling the joint point change magnitude of the joint point preset magnitude range.

For a specific process of performing multiplication operation on the angle value rotation magnitude and the confidence rotation magnitude, reference may be made to the following formula (5).

$$w = {w}_{1} * {w}_{2} \qquad ( 5 )$$

In formula (5), w₁ may indicate the angle value rotation magnitude, w₂ may indicate the confidence rotation magnitude, and w may indicate virtual rotation magnitude.

In this embodiment, the angle value rotation magnitude corresponding to the joint point may be determined based on the angle value range to which the detected rotation angle value belongs, and the confidence rotation magnitude corresponding to the joint point is determined based on the confidence range to which the target position confidence of the joint point in the target video frame belongs. Then, the virtual rotation magnitude configured for controlling the joint point change magnitude of the joint point preset magnitude range is generated by performing multiplication operation on the angle value rotation magnitude and the confidence rotation magnitude. Therefore, in this embodiment, the virtual rotation magnitude for controlling the joint point change magnitude of the joint point within the preset magnitude range may be determined based on the detected rotation angle value and the target position confidence, thereby improving accuracy of the obtained virtual rotation magnitude.

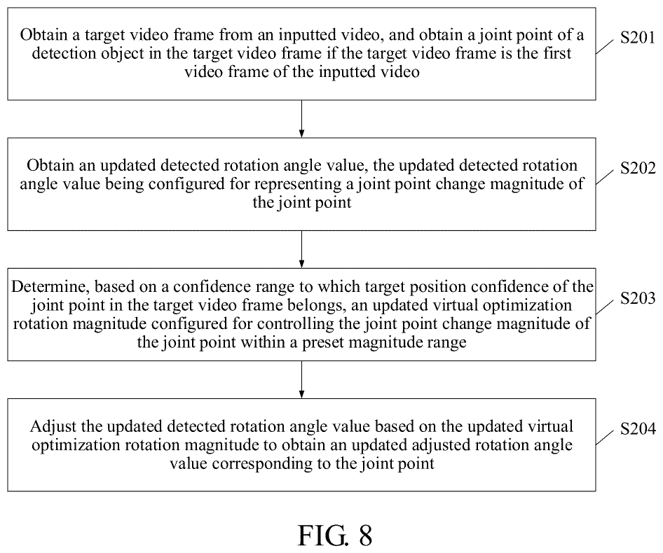

Further, FIG. 8 is a schematic flowchart of a data processing method according to an embodiment of this application. The method may be performed by a server, performed by a terminal device, or performed jointly by a server and a terminal device. The server may be the server 20a in the embodiment corresponding to FIG. 2. The terminal device may be the terminal device 20b in the embodiment corresponding to FIG. 2. The data processing method may include the following operation S201 to operation S204.

Operation S201: Obtain a target video frame from an inputted video, and obtain a joint point of a detected object in the target video frame if the target video frame is the first video frame of the inputted video.

For a specific process of obtaining the joint point of the detected object in the target video frame, reference may be made to the foregoing descriptions of operation S101 in the embodiment corresponding to FIG. 3.

Operation S202: Obtain an updated detected rotation angle value, the updated detected rotation angle value being configured for representing a joint point change magnitude of the joint point.

Specifically, a target rotation matrix corresponding to the joint point is determined based on target coordinate information of the joint point in the target video frame. A default rotation matrix corresponding to the joint point is determined based on default coordinate information corresponding to the joint point on the default detected object. Further, an updated joint point rotation matrix of the joint point is determined based on the target rotation matrix and the default rotation matrix. Further, the updated joint point rotation matrix is converted into an updated joint point rotation vector, and the updated detected rotation angle value configured for representing the joint point change magnitude of the joint point is generated based on the updated joint point rotation vector. The updated detected rotation angle value is determined based on the target coordinate information of the joint point in the target video frame and the default coordinate information corresponding to the joint point of a default detected object.

In other words, the target rotation matrix corresponding to the joint point is determined based on the target coordinate information of the joint point in the target video frame. The default rotation matrix corresponding to the joint point is determined based on the default coordinate information corresponding to the joint point. Further, an updated joint point rotation matrix of the joint point is determined based on the target rotation matrix and the default rotation matrix. Further, the updated joint point rotation matrix is converted into an updated joint point rotation vector, and the updated detected rotation angle value configured for representing the joint point change magnitude of the joint point is generated based on the updated joint point rotation vector. The updated detected rotation angle value is determined based on the target coordinate information of the joint point in the target video frame and the default coordinate information corresponding to the joint point.

For a specific process of determining the target rotation matrix corresponding to the joint point based on the target coordinate information of the joint point in the target video frame, reference may be made to the foregoing descriptions of operation S1021 in the embodiment corresponding to FIG. 6. Details are not described herein again. For a specific process of determining the default rotation matrix corresponding to the joint point based on the default coordinate information corresponding to the joint point of the default detected object, reference may be made to the foregoing descriptions in the embodiment corresponding to FIG. 6 of determining the target rotation matrix corresponding to the joint point based on the target coordinate information of the joint point in the target video frame. Details are not described herein again. For a specific process of determining the updated joint point rotation matrix of the joint point based on the target rotation matrix and the default rotation matrix, reference may be made to the foregoing descriptions in the embodiment corresponding to FIG. 6 of determining the joint point rotation matrix of the joint point from the reference video frame to the target video frame based on the target rotation matrix and the reference rotation matrix. Details are not described herein again.

The default detected object may be the same as the detected object in the target video frame, or different from the detected object in the target video frame. For example, the detected object may be an object Y₁, and the default detected object may be an object Y₂.

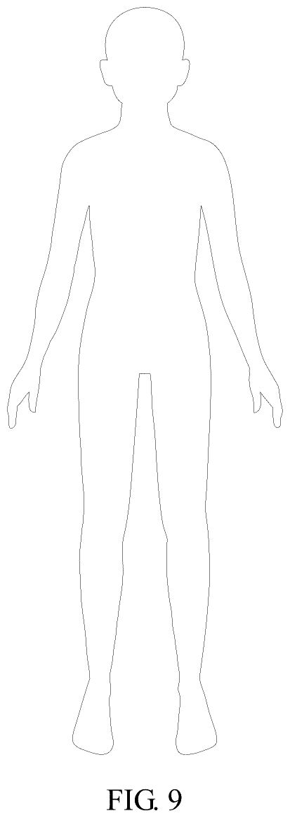

For ease of understanding, FIG. 9 is a schematic diagram of a structure of a default detected object according to an embodiment of this application. FIG. 9 shows the default detected object. The default detected object may include a joint point (where for the joint point of the default detected object, reference may be made to the foregoing descriptions of the embodiment corresponding to FIG. 4). The posture of the default detected object may be as shown in FIG. 9 (to be specific, the posture of the default detected object may be standing vertically with both hands hanging down), or may be other postures. The posture of the default detected object is not limited in the embodiment of this application.

Operation S203: Determine, based on the confidence range to which the target position confidence of the joint point in the target video frame belongs, an updated virtual rotation magnitude configured for controlling the joint point change magnitude of the joint point within a preset magnitude range.

Specifically, a confidence rotation magnitude corresponding to the joint point is determined based on the confidence range to which the target position confidence of the joint point in the target video frame belongs. Further, the confidence rotation magnitude is determined as the updated virtual rotation magnitude configured for controlling the joint point change magnitude of the joint point within the preset magnitude range. In other words, the updated virtual rotation magnitude configured for controlling the joint point change magnitude of the joint point within the preset magnitude range is generated by performing multiplication operation on the confidence rotation magnitude and a default angle value rotation magnitude. A specific value of the default angle value rotation magnitude is not limited in this embodiment. For example, the default angle value rotation magnitude may be equal to 1. To be specific, when the target video frame is the first video frame of the inputted video, the default angle value rotation magnitude (that is, w₁) is equal to 1.

For a specific process of determining the confidence rotation magnitude corresponding to the joint point based on the confidence range to which the target position confidence of the joint point in the target video frame belongs, reference may be made to the foregoing descriptions of operation S1032 in the embodiment corresponding to FIG. 7. Details are not described herein again.

Operation S204: Adjust the updated detected rotation angle value based on the updated virtual rotation magnitude to obtain an updated adjusted rotation angle value corresponding to the joint point.

Specifically, the updated adjusted rotation angle value corresponding to the joint point, that is, the updated adjusted rotation angle value configured for representing the joint point change magnitude of the joint point is generated by performing multiplication operation on the updated virtual rotation magnitude and the updated detected rotation angle value. The updated adjusted rotation angle value is configured for performing object driving on a virtual object in a default virtual image to obtain the virtual object in a target virtual image associated with the target video frame. The virtual object in the default virtual image is obtained by performing object simulation on the default detected object. The virtual object in the target virtual image is obtained by performing object simulation on the detected object in the target video frame.

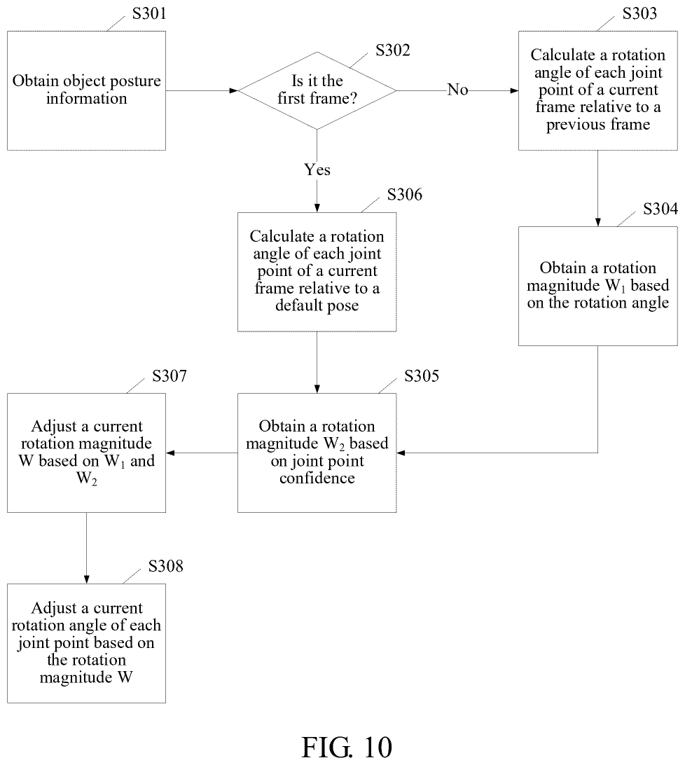

For ease of understanding, FIG. 10 is a schematic flowchart of driving a virtual object according to an embodiment of this application. For ease of understanding, an example in which a terminal device is an execution entity is used as an example in this embodiment. As shown in FIG. 10, the terminal device may perform operation S301. Object posture information (that is, 3D human body posture information) is obtained through operation S301. To be specific, a target video frame (that is, a current frame) is inputted into a posture estimation model, posture estimation is performed on the target video frame through the posture estimation model, and a joint point of a detected object in the target video frame is outputted to obtain target coordinate information of the joint point in the target video frame and target position confidence of the target coordinate information. The target coordinate information and the target position confidence may be collectively referred to as object posture information.

Further, as shown in FIG. 10, the terminal device may perform operation S302. It is determined, through operation S302, whether the target video frame is the first frame, that is, it is determined whether the target video frame is the first video frame in the inputted video. As shown in FIG. 10, if the target video frame is the first frame, the terminal device may perform operation S306, and a rotation angle (that is, a rotation angle value Q) of each joint point of the current frame relative to a default posture (that is, a posture of a default detected object) is calculated through operation S306. To be specific, an updated detected rotation angle value is obtained, and the updated detected rotation angle value is configured for representing a joint point change magnitude of the joint point. Further, the terminal device may perform operation S305. A rotation magnitude W₂ is obtained based on joint point confidence (that is, the target position confidence) through operation S305. To be specific, a confidence rotation magnitude (that is, the rotation magnitude W₂) corresponding to the joint point is determined based on a confidence range to which the target position confidence of the joint point in the target video frame belongs. Further, the terminal device may perform operation S307. A current rotation magnitude W is adjusted based on W₁ (that is, a rotation magnitude W₁) and W₂ (that is, the rotation magnitude W₂) through operation S307. To be specific, an updated virtual rotation magnitude (that is, a rotation magnitude W) configured for controlling the joint point change magnitude of the joint point within a preset magnitude range is generated by performing multiplication operation on the confidence rotation magnitude (that is, the rotation magnitude W₂) and a default angle value rotation magnitude (that is, the rotation magnitude W₁). Further, the terminal device may perform operation S308. A current rotation angle of each joint point (that is, the updated detected rotation angle value) is adjusted based on the rotation magnitude W through operation S308. To be specific, the updated detected rotation angle value is adjusted based on the updated virtual rotation magnitude to obtain an updated adjusted rotation angle value corresponding to the joint point.

In one embodiment, as shown in FIG. 10, if the target video frame is not the first frame, the terminal device may perform operation S303. A rotation angle (that is, the rotation angle value Q) of each joint point of a current frame (that is, the target video frame) relative to a previous frame (that is, a reference video frame) is calculated through operation S303. To be specific, the detected rotation angle value configured for representing the joint point change magnitude of the joint point from the reference video frame to the target video frame is obtained. Further, the terminal device may perform operation S304. The rotation magnitude W₁ is obtained based on a rotation angle (that is, the detected rotation angle value) through operation S304. To be specific, an angle value rotation magnitude (that is, the rotation magnitude W₁) corresponding to the joint point may be determined based on the angle value range to which the detected rotation angle value belongs. Further, the terminal device may perform operation S305. The rotation magnitude W₂ is obtained based on the joint point confidence (that is, the target position confidence) through operation S305. Further, the terminal device may perform operation S307. A current rotation magnitude W is adjusted based on W₁ (that is, a rotation magnitude W₁) and W₂ (that is, the rotation magnitude W₂) through operation S307. To be specific, a virtual rotation magnitude (that is, a rotation magnitude W) configured for controlling the joint point change magnitude of the joint point within a preset magnitude range is generated by performing multiplication operation on the angle value rotation magnitude (that is, the rotation magnitude W₁) and the confidence rotation magnitude (that is, the rotation magnitude W₂). Further, the terminal device may perform operation S308. A current rotation angle (that is, the detected rotation angle value) of each joint point is adjusted based on the rotation magnitude W through operation S308. To be specific, the detected rotation angle value is adjusted based on the virtual rotation magnitude to obtain an adjusted rotation angle value corresponding to the joint point.

In this embodiment, when the target video frame is the first video frame of the inputted video, the joint point of the detected object in the target video frame may be obtained, and then after the updated detected rotation angle value is obtained, where the updated detected rotation angle value is configured for representing the joint point change magnitude of the joint point, the updated virtual rotation magnitude configured for controlling the joint point change magnitude of the joint point within the preset magnitude range is determined based on a confidence range to which the joint point confidence (that is, the target position confidence) belongs, so that the updated detected rotation angle value is adjusted based on the updated virtual rotation magnitude to obtain the updated adjusted rotation angle value. The updated adjusted rotation angle value may be configured for performing object driving on the virtual object in the default virtual image to obtain the virtual object in the target virtual image associated with the target video frame Accordingly, when accuracy of the updated detected rotation angle value is not high, the updated detected rotation angle value with low accuracy may be adjusted based on the updated virtual rotation magnitude to obtain an updated adjusted rotation angle value with higher accuracy, so that stability of object driving of the virtual object is improved.

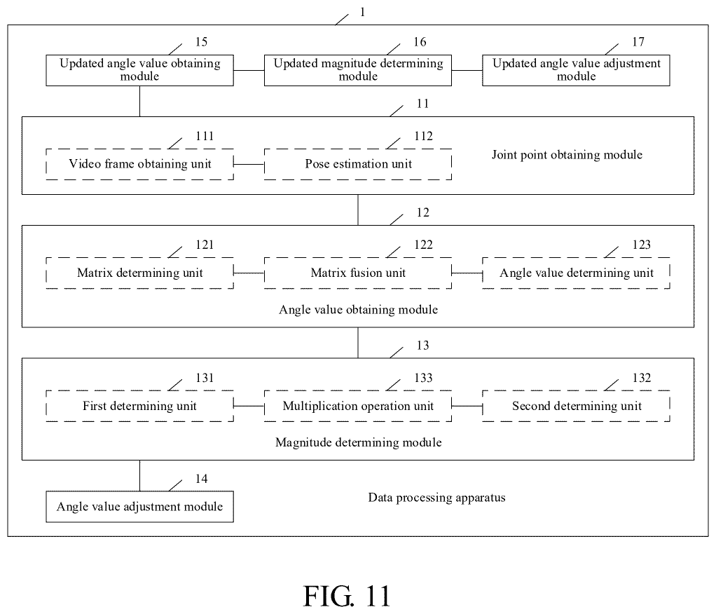

Further, FIG. 11 is a schematic diagram of a structure of a data processing apparatus according to an embodiment of this application. The data processing apparatus 1 may include a joint point obtaining module 11, an angle value obtaining module 12, a magnitude determining module 13, and an angle value adjustment module 14. Further, the data processing apparatus 1 may further include an updated angle value obtaining module 15, an updated magnitude determining module 16, and an updated angle value adjustment module 17.

The joint point obtaining module 11 is configured to: obtain a target video frame and a reference video frame from an inputted video, and extract a joint point of a detected object separately from the target video frame and the reference video frame. The reference video frame is a previous video frame of the target video frame.

The joint point obtaining module 11 includes a video frame obtaining unit 111 and a posture estimation unit 112.

The video frame obtaining unit 111 is configured to obtain the target video frame from the inputted video, obtain the previous video frame of the target video frame from the inputted video if the target video frame is not the first video frame of the inputted video, and determine the previous video frame of the target video frame as the reference video frame.

The posture estimation unit 112 is configured to input the target video frame into a posture estimation model, perform posture estimation on the target video frame by using the posture estimation model, and output the joint point of the detected object in the target video frame.

The posture estimation unit 112 is configured to input the reference video frame into the posture estimation model, perform posture estimation on the reference video frame by using the posture estimation model, and output the joint point of the detected object in the reference video frame.

For specific implementations of the video frame obtaining unit 111 and the posture estimation unit 112, reference may be made to the foregoing descriptions of operation S101 in the embodiment corresponding to FIG. 3. Details are not described herein again.

The joint point obtaining module 11 is further specifically configured to output target coordinate information of the joint point in the target video frame by using the posture estimation model.

The joint point obtaining module 11 is further specifically configured to output reference coordinate information of the joint point in the reference video frame by using the posture estimation model.

The angle value obtaining module 12 is specifically configured to generate, based on the target coordinate information of the joint point in the target video frame and the reference coordinate information of the joint point in the reference video frame, the detected rotation angle value configured for representing the joint point change magnitude of the joint point.

The angle value obtaining module 12 is configured to obtain a detected rotation angle value configured for representing a joint point change magnitude of the joint point from the reference video frame to the target video frame.

The angle value obtaining module 12 includes a matrix determining unit 121, a matrix fusion unit 122, and an angle value determining unit 123.

The matrix determining unit 121 is configured to determine a target rotation matrix corresponding to the joint point based on the target coordinate information of the joint point in the target video frame.

A quantity of joint points is S, S is a positive integer greater than 1, and S joint points include a target joint point.

The matrix determining unit 121 is specifically configured to obtain a target joint point type corresponding to the target joint point.

The matrix determining unit 121 is specifically configured to obtain a sub-joint point of the target joint point from the S joint points if the target joint point type is a joint point type corresponding to a root joint point, and determine a target rotation matrix corresponding to the target joint point based on target coordinate information of the target joint point in the target video frame and target coordinate information of the sub-joint point in the target video frame.

The matrix determining unit 121 is specifically configured to obtain a parent joint point of the target joint point from the S joint points if the target joint point type is a joint point type corresponding to a non-root joint point, and determine a target rotation matrix corresponding to the target joint point based on target coordinate information of the target joint point in the target video frame and target coordinate information of the parent joint point in the target video frame.

The matrix determining unit 121 is configured to determine a reference rotation matrix corresponding to the joint point based on the reference coordinate information of the joint point in the reference video frame.

The matrix fusion unit 122 is configured to determine a joint point rotation matrix of the joint point from the reference video frame to the target video frame based on the target rotation matrix and the reference rotation matrix.

The matrix fusion unit 122 is specifically configured to perform inverse transformation on the reference rotation matrix to obtain an inverse reference rotation matrix of the reference rotation matrix.

The matrix fusion unit 122 is specifically configured to perform matrix multiplication on the inverse reference rotation matrix and the target rotation matrix to obtain the joint point rotation matrix of the joint point from the reference video frame to the target video frame.

The angle value determining unit 123 is configured to convert the joint point rotation matrix into a joint point rotation vector, and generate, based on the joint point rotation vector, the detected rotation angle value configured for representing the joint point change magnitude of the joint point.

For specific implementations of the matrix determining unit 121, the matrix fusion unit 122, and the angle value determining unit 123, reference may be made to the foregoing descriptions of operation S102 in the embodiment corresponding to FIG. 3 and the foregoing descriptions of operation S1021 to operation S1024 in the embodiment corresponding to FIG. 6. Details are not described herein again.

The magnitude determining module 13 is configured to determine, based on an angle value range to which the detected rotation angle value belongs and a confidence range to which target position confidence of the joint point in the target video frame belongs, a virtual rotation magnitude configured for controlling the joint point change magnitude of the joint point within a preset magnitude range.

The target position confidence is confidence of target coordinate information of the joint point in the target video frame outputted by the posture estimation model.

The magnitude determining module 13 includes a first determining unit 131, a second determining unit 132, and a multiplication operation unit 133.

The first determining unit 131 is configured to determine an angle value rotation magnitude corresponding to the joint point based on the angle value range to which the detected rotation angle value belongs.

The first determining unit 131 is specifically configured to obtain an angle value range parameter corresponding to the angle value range to which the detected rotation angle value belongs, and obtain a part area corresponding to the joint point.

The first determining unit 131 is specifically configured to determine the angle value range parameter as the angle value rotation magnitude corresponding to the joint point if the part area belongs to a trunk area.

The first determining unit 131 is specifically configured to perform, if the part area belongs to a non-trunk area, expansion processing on the angle value range parameter to obtain an angle value expansion parameter, and determine a larger value of the angle value expansion parameter and a preset parameter as the angle value rotation magnitude corresponding to the joint point.

The second determining unit 132 is configured to determine a confidence rotation magnitude corresponding to the joint point based on the confidence range to which the target position confidence of the joint point in the target video frame belongs.

The second determining unit 132 is specifically configured to determine a first confidence range parameter corresponding to a first confidence range as the confidence rotation magnitude corresponding to the joint point if the confidence range to which the target position confidence of the joint point in the target video frame belongs is the first confidence range.

The second determining unit 132 is specifically configured to perform, if the confidence range to which the target position confidence of the joint point in the target video frame belongs is a second confidence range, operation processing on the target position confidence to obtain a second confidence range parameter corresponding to the second confidence range, and determine the second confidence range parameter as the confidence rotation magnitude corresponding to the joint point.

The multiplication operation unit 133 is configured to generate, by performing multiplication operation on the angle value rotation magnitude and the confidence rotation magnitude, the virtual rotation magnitude configured for controlling the joint point change magnitude of the joint point within the preset magnitude range.

For specific implementations of the first determining unit 131, the second determining unit 132, and the multiplication operation unit 133, reference may be made to the foregoing descriptions of operation S103 in the embodiment corresponding to FIG. 3 and the foregoing descriptions of operation S1031 to operation S1033 in the embodiment corresponding to FIG. 7. Details are not described herein again.

The angle value adjustment module 14 is configured to adjust the detected rotation angle value based on the virtual rotation magnitude to obtain an adjusted rotation angle value corresponding to the joint point. The adjusted rotation angle value is configured for performing object driving on the virtual object in the reference virtual image associated with the reference video frame to obtain the virtual object in the target virtual image associated with the target video frame. The virtual object in the reference virtual image is obtained by performing object simulation on the detected object in the reference video frame.

The angle value adjustment module 14 is specifically configured to generate the adjusted rotation angle value corresponding to the joint point by performing multiplication operation on the virtual rotation magnitude and the detected rotation angle value.

In one embodiment, the joint point obtaining module 11 is configured to obtain the joint point of the detected object in the target video frame if the target video frame is the first video frame of the inputted video.

The updated angle value obtaining module 15 is configured to obtain an updated detected rotation angle value. The updated detected rotation angle value is configured for representing the joint point change magnitude of the joint point. The updated detected rotation angle value is determined based on the target coordinate information of the joint point in the target video frame and the default coordinate information corresponding to the joint point of a default detected object.

The updated magnitude determining module 16 is configured to determine, based on the confidence range to which the target position confidence of the joint point in the target video frame belongs, an updated virtual rotation magnitude configured for controlling the joint point change magnitude of the joint point within the preset magnitude range.

The updated angle value adjustment module 17 is configured to adjust the updated detected rotation angle value based on the updated virtual rotation magnitude to obtain an updated adjusted rotation angle value corresponding to the joint point. The updated adjusted rotation angle value is configured for performing object driving on a virtual object in a default virtual image to obtain the virtual object in a target virtual image associated with the target video frame. The virtual object in the default virtual image is obtained by performing object simulation on the default detected object.

For specific implementations of the joint point obtaining module 11, the angle value obtaining module 12, the magnitude determining module 13, and the angle value adjustment module 14, reference may be made to the foregoing descriptions of operation S101 to operation S104 in the embodiment corresponding to FIG. 3, the foregoing descriptions of operation S1021 to operation S1024 in the embodiment corresponding to FIG. 6, and the foregoing descriptions of operation S1031 to operation S1033 in the embodiment corresponding to FIG. 7. Details are not described herein again. For specific implementations of the joint point obtaining module 11, the updated angle value obtaining module 15, the updated magnitude determining module 16, and the updated angle value adjustment module 17, reference may be made to the foregoing descriptions of operation S201 to operation S204 in the embodiment corresponding to FIG. 8. Details are not described herein again. In addition, beneficial effects of using the same method are not described in detail again.

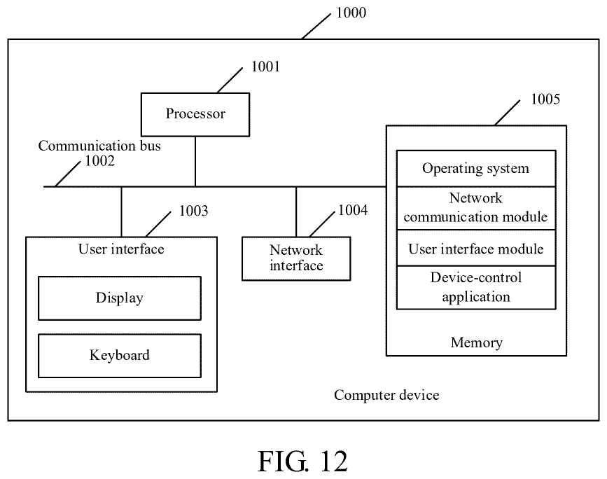

Further, FIG. 12 is a schematic diagram of a computer device according to an embodiment of this application. The computer device may be a terminal device or a server. As shown in FIG. 12, the computer device 1000 may include a processor 1001, a network interface 1004, and a memory 1005. In addition, the computer device 1000 may further include a user interface 1003 and at least one communication bus 1002. The communication bus 1002 is configured to implement connection and communication between these components. In some embodiments, the user interface 1003 may include a display, a keyboard, and optionally, the user interface 1003 may further include a standard wired interface and a standard wireless interface. In one embodiment, the network interface 1004 may include a standard wired interface and a standard wireless interface (such as a Wi-Fi interface). The memory 1005 may be a high-speed RAM memory, or may be a non-volatile memory, for example, at least one magnetic disk memory. In one embodiment, the memory 1005 may alternatively be at least one storage apparatus that is located far away from the processor 1001. As shown in FIG. 12, the memory 1005 used as a computer-readable storage medium may include an operating system, a network communication module, a user interface module, and a device-control application.

In the computer device 1000 shown in FIG. 12, the network interface 1004 may provide a network communication function. The user interface 1003 is mainly configured to provide an input interface for a user. The processor 1001 may be configured to invoke the device-control application stored in the memory 1005 to implement the following operations:
obtaining a target video frame and a reference video frame from an inputted video, and extracting a joint point of a detected object separately from the target video frame and the reference video frame, the reference video frame being a previous video frame of the target video frame;
obtaining a detected rotation angle value configured for representing a joint point change magnitude of the joint point from the reference video frame to the target video frame;
determining, based on an angle value range to which the detected rotation angle value belongs and a confidence range to which target position confidence of the joint point in the target video frame belongs, a virtual rotation magnitude configured for controlling the joint point change magnitude of the joint point within a preset magnitude range; and
adjusting the detected rotation angle value based on the virtual rotation magnitude to obtain an adjusted rotation angle value corresponding to the joint point.

The adjusted rotation angle value is configured for performing object driving on the virtual object in the reference virtual image associated with the reference video frame to obtain the virtual object in the target virtual image associated with the target video frame. The virtual object in the reference virtual image is obtained by performing object simulation on the detected object in the reference video frame.

The computer device 1000 described in this embodiment may implement the descriptions of the data processing method in the foregoing embodiment corresponding to FIG. 3, FIG. 6, FIG. 7, or FIG. 8, and may also implement the descriptions of the data processing apparatus 1 in the foregoing embodiment corresponding to FIG. 11. Details are not described herein again. In addition, beneficial effects of using the same method are not described in detail again.

In addition, an embodiment of this application further provides a computer-readable storage medium. The computer-readable storage medium stores a computer program executed by the foregoing data processing apparatus 1. When a processor executes the computer program, the descriptions of the data processing method in the foregoing embodiment corresponding to FIG. 3, FIG. 6, FIG. 7, or FIG. 8 can be implemented. Therefore, details are not described herein again. In addition, beneficial effects of using the same method are not described in detail again. For technical details that are not disclosed in the computer-readable storage medium embodiment of this application, reference is made to the descriptions of the method embodiments of this application.

In addition, an embodiment of this application further provides a computer program product. The computer program product may include a computer program, and the computer program may be stored in a computer-readable storage medium. A processor of a computer device reads the computer program from the computer-readable storage medium, and the processor may execute the computer program, so that the computer device executes the foregoing description of the data processing method in the embodiment corresponding to FIG. 3, FIG. 6, FIG. 7, or FIG. 8. Therefore, details are not described herein again. In addition, beneficial effects of using the same method are not described in detail again. For technical details that are not disclosed in the computer program product embodiment of this application, reference is made to the descriptions of the method embodiment of this application.

A person of ordinary skill in the art may understand that all or some of the processes of the methods in embodiments may be implemented by a computer program instructing relevant hardware. The computer program may be stored in a computer-readable storage medium. When the program is executed, the processes of the foregoing method embodiments are performed. The foregoing storage medium may be a magnetic disc, an optical disc, a read-only memory (ROM), a random access memory (RAM), or the like.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A data processing method, comprising:
obtaining a target video frame and a reference video frame from an inputted video, and extracting a joint point of a detected object separately from the target video frame and the reference video frame, the reference video frame being a previous video frame of the target video frame;
obtaining a rotation angle value representing a joint point change magnitude of the joint point from the reference video frame to the target video frame;
determining, based on an angle value range to which the rotation angle value belongs and a confidence range to which target position confidence of the joint point in the target video frame belongs, a virtual rotation magnitude for controlling the joint point change magnitude of the joint point within a preset magnitude range; and
adjusting the rotation angle value based on the virtual rotation magnitude to obtain an adjusted rotation angle value corresponding to the joint point.

2. The method according to claim 1, wherein the obtaining a target video frame and a reference video frame from an inputted video, and extracting a joint point of a detected object separately from the target video frame and the reference video frame comprises:
obtaining the target video frame from the inputted video, obtaining the previous video frame of the target video frame from the inputted video if the target video frame is not the first video frame of the inputted video, and determining the previous video frame of the target video frame as the reference video frame;
inputting the target video frame into a posture estimation model, performing posture estimation on the target video frame by using the posture estimation model, and outputting the joint point of the detected object in the target video frame; and
inputting the reference video frame into the posture estimation model, performing posture estimation on the reference video frame by using the posture estimation model, and outputting the joint point of the detected object in the reference video frame.

3. The method according to claim 2, further comprising:
obtaining the joint point of the detected object in the target video frame if the target video frame is the first video frame of the inputted video;
obtaining an updated detected rotation angle value, the updated detected rotation angle value representing the joint point change magnitude of the joint point, and the updated detected rotation angle value being determined based on target coordinate information of the joint point in the target video frame and default coordinate information corresponding to the joint point of a default detected object;
determining, based on the confidence range to which the target position confidence of the joint point in the target video frame belongs, an updated virtual rotation magnitude for controlling the joint point change magnitude of the joint point within the preset magnitude range; and
adjusting the updated detected rotation angle value based on the updated virtual rotation magnitude to obtain an updated adjusted rotation angle value corresponding to the joint point, the updated adjusted rotation angle value being used for performing object driving on a virtual object in a default virtual image to obtain the virtual object in a target virtual image associated with the target video frame, and the virtual object in the default virtual image being obtained by performing object simulation on the default detected object.

4. The method according to claim 2, wherein the method further comprises:
outputting target coordinate information of the joint point in the target video frame by using the posture estimation model; and
outputting reference coordinate information of the joint point in the reference video frame by using the posture estimation model; and
the obtaining a detected rotation angle value representing a joint point change magnitude of the joint point from the reference video frame to the target video frame comprises:
generating, based on the target coordinate information of the joint point in the target video frame and the reference coordinate information of the joint point in the reference video frame, the detected rotation angle value representing the joint point change magnitude of the joint point.

5. The method according to claim 4, wherein the generating, based on the target coordinate information of the joint point in the target video frame and the reference coordinate information of the joint point in the reference video frame, the detected rotation angle value representing the joint point change magnitude of the joint point comprises:
determining a target rotation matrix corresponding to the joint point based on the target coordinate information of the joint point in the target video frame;
determining a reference rotation matrix corresponding to the joint point based on the reference coordinate information of the joint point in the reference video frame;
determining a joint point rotation matrix of the joint point from the reference video frame to the target video frame based on the target rotation matrix and the reference rotation matrix; and
converting the joint point rotation matrix into a joint point rotation vector, and generating, based on the joint point rotation vector, the detected rotation angle value representing the joint point change magnitude of the joint point.

6. The method according to claim 5, wherein a quantity of joint points is S, S is a positive integer greater than 1, and S joint points comprise a target joint point; and
the determining a target rotation matrix corresponding to the joint point based on the target coordinate information of the joint point in the target video frame comprises:
obtaining a target joint point type corresponding to the target joint point; and
obtaining a sub-joint point of the target joint point from the S joint points if the target joint point type is a joint point type corresponding to a root joint point, and determining a target rotation matrix corresponding to the target joint point based on target coordinate information of the target joint point in the target video frame and target coordinate information of the sub-joint point in the target video frame; or
obtaining a parent joint point of the target joint point from the S joint points if the target joint point type is a joint point type corresponding to a non-root joint point, and determining a target rotation matrix corresponding to the target joint point based on target coordinate information of the target joint point in the target video frame and target coordinate information of the parent joint point in the target video frame.

7. The method according to claim 5, wherein the determining a joint point rotation matrix of the joint point from the reference video frame to the target video frame based on the target rotation matrix and the reference rotation matrix comprises:
performing inverse transformation on the reference rotation matrix to obtain an inverse reference rotation matrix of the reference rotation matrix; and
performing matrix multiplication on the inverse reference rotation matrix and the target rotation matrix to obtain the joint point rotation matrix of the joint point from the reference video frame to the target video frame.

8. The method according to claim 2, wherein the target position confidence is confidence of target coordinate information of the joint point in the target video frame outputted by the posture estimation model; and
the determining, based on an angle value range to which the detected rotation angle value belongs and a confidence range to which target position confidence of the joint point in the target video frame belongs, a virtual rotation magnitude configured for controlling the joint point change magnitude of the joint point within a preset magnitude range comprises:
determining an angle value rotation magnitude corresponding to the joint point based on the angle value range to which the detected rotation angle value belongs;
determining a confidence rotation magnitude corresponding to the joint point based on the confidence range to which the target position confidence of the joint point in the target video frame belongs; and
generating, by performing multiplication operation on the angle value rotation magnitude and the confidence rotation magnitude, the virtual rotation magnitude configured for controlling the joint point change magnitude of the joint point within the preset magnitude range.

9. The method according to claim 8, wherein the determining an angle value rotation magnitude corresponding to the joint point based on the angle value range to which the detected rotation angle value belongs comprises:
obtaining an angle value range parameter corresponding to the angle value range to which the detected rotation angle value belongs, and obtaining a part area corresponding to the joint point;
determining the angle value range parameter as the angle value rotation magnitude corresponding to the joint point if the part area belongs to a trunk area; and
performing, if the part area belongs to a non-trunk area, expansion processing on the angle value range parameter to obtain an angle value expansion parameter, and determining a larger value of the angle value expansion parameter and a preset parameter as the angle value rotation magnitude corresponding to the joint point.

10. The method according to claim 8, wherein the determining a confidence rotation magnitude corresponding to the joint point based on the confidence range to which the target position confidence of the joint point in the target video frame belongs comprises:
determining a first confidence range parameter corresponding to a first confidence range as the confidence rotation magnitude corresponding to the joint point if the confidence range to which the target position confidence of the joint point in the target video frame belongs is the first confidence range; and
performing, if the confidence range to which the target position confidence of the joint point in the target video frame belongs is a second confidence range, operation processing on the target position confidence to obtain a second confidence range parameter corresponding to the second confidence range, and determining the second confidence range parameter as the confidence rotation magnitude corresponding to the joint point.

11. The method according to claim 1, wherein the adjusting the detected rotation angle value based on the virtual rotation magnitude to obtain an adjusted rotation angle value corresponding to the joint point comprises:
generating the adjusted rotation angle value corresponding to the joint point by multiplying the virtual rotation magnitude and the detected rotation angle value.

12. A computer device, comprising: a processor and a memory,
the processor and the memory being connected, the memory being configured to store a computer program, and the processor being configured to invoke the computer program, to cause the computer device to perform a data processing method, comprising:
obtaining a target video frame and a reference video frame from an inputted video, and extracting a joint point of a detected object separately from the target video frame and the reference video frame, the reference video frame being a previous video frame of the target video frame;
obtaining a rotation angle value representing a joint point change magnitude of the joint point from the reference video frame to the target video frame;
determining, based on an angle value range to which the rotation angle value belongs and a confidence range to which target position confidence of the joint point in the target video frame belongs, a virtual rotation magnitude for controlling the joint point change magnitude of the joint point within a preset magnitude range; and
adjusting the rotation angle value based on the virtual rotation magnitude to obtain an adjusted rotation angle value corresponding to the joint point.

13. The computer device according to claim 12, wherein the obtaining a target video frame and a reference video frame from an inputted video, and extracting a joint point of a detected object separately from the target video frame and the reference video frame comprises:
obtaining the target video frame from the inputted video, obtaining the previous video frame of the target video frame from the inputted video if the target video frame is not the first video frame of the inputted video, and determining the previous video frame of the target video frame as the reference video frame;
inputting the target video frame into a posture estimation model, performing posture estimation on the target video frame by using the posture estimation model, and outputting the joint point of the detected object in the target video frame; and
inputting the reference video frame into the posture estimation model, performing posture estimation on the reference video frame by using the posture estimation model, and outputting the joint point of the detected object in the reference video frame.

14. The computer device according to claim 13, the method further comprising:
obtaining the joint point of the detected object in the target video frame if the target video frame is the first video frame of the inputted video;
obtaining an updated detected rotation angle value, the updated detected rotation angle value representing the joint point change magnitude of the joint point, and the updated detected rotation angle value being determined based on target coordinate information of the joint point in the target video frame and default coordinate information corresponding to the joint point of a default detected object;
determining, based on the confidence range to which the target position confidence of the joint point in the target video frame belongs, an updated virtual rotation magnitude for controlling the joint point change magnitude of the joint point within the preset magnitude range; and
adjusting the updated detected rotation angle value based on the updated virtual rotation magnitude to obtain an updated adjusted rotation angle value corresponding to the joint point, the updated adjusted rotation angle value being used for performing object driving on a virtual object in a default virtual image to obtain the virtual object in a target virtual image associated with the target video frame, and the virtual object in the default virtual image being obtained by performing object simulation on the default detected object.

15. The computer device according to claim 13, wherein the method further comprises:
outputting target coordinate information of the joint point in the target video frame by using the posture estimation model; and
outputting reference coordinate information of the joint point in the reference video frame by using the posture estimation model; and
the obtaining a detected rotation angle value representing a joint point change magnitude of the joint point from the reference video frame to the target video frame comprises:
generating, based on the target coordinate information of the joint point in the target video frame and the reference coordinate information of the joint point in the reference video frame, the detected rotation angle value representing the joint point change magnitude of the joint point.

16. The computer device according to claim 15, wherein the generating, based on the target coordinate information of the joint point in the target video frame and the reference coordinate information of the joint point in the reference video frame, the detected rotation angle value representing the joint point change magnitude of the joint point comprises:
determining a target rotation matrix corresponding to the joint point based on the target coordinate information of the joint point in the target video frame;
determining a reference rotation matrix corresponding to the joint point based on the reference coordinate information of the joint point in the reference video frame;
determining a joint point rotation matrix of the joint point from the reference video frame to the target video frame based on the target rotation matrix and the reference rotation matrix; and
converting the joint point rotation matrix into a joint point rotation vector, and generating, based on the joint point rotation vector, the detected rotation angle value representing the joint point change magnitude of the joint point.

17. The computer device according to claim 16, wherein a quantity of joint points is S, S is a positive integer greater than 1, and S joint points comprise a target joint point; and
the determining a target rotation matrix corresponding to the joint point based on the target coordinate information of the joint point in the target video frame comprises:
obtaining a target joint point type corresponding to the target joint point; and
obtaining a sub-joint point of the target joint point from the S joint points if the target joint point type is a joint point type corresponding to a root joint point, and determining a target rotation matrix corresponding to the target joint point based on target coordinate information of the target joint point in the target video frame and target coordinate information of the sub-joint point in the target video frame; or
obtaining a parent joint point of the target joint point from the S joint points if the target joint point type is a joint point type corresponding to a non-root joint point, and determining a target rotation matrix corresponding to the target joint point based on target coordinate information of the target joint point in the target video frame and target coordinate information of the parent joint point in the target video frame.

18. A non-transitory computer-readable storage medium, having a computer program stored thereon, the computer program being loadable and executable by a processor, to cause a computer device having the processor to perform a data processing method, comprising:
obtaining a target video frame and a reference video frame from an inputted video, and extracting a joint point of a detected object separately from the target video frame and the reference video frame, the reference video frame being a previous video frame of the target video frame;
obtaining a rotation angle value representing a joint point change magnitude of the joint point from the reference video frame to the target video frame;
determining, based on an angle value range to which the rotation angle value belongs and a confidence range to which target position confidence of the joint point in the target video frame belongs, a virtual rotation magnitude for controlling the joint point change magnitude of the joint point within a preset magnitude range; and
adjusting the rotation angle value based on the virtual rotation magnitude to obtain an adjusted rotation angle value corresponding to the joint point.

19. The computer-readable storage medium according to claim 18, wherein the obtaining a target video frame and a reference video frame from an inputted video, and extracting a joint point of a detected object separately from the target video frame and the reference video frame comprises:
obtaining the target video frame from the inputted video, obtaining the previous video frame of the target video frame from the inputted video if the target video frame is not the first video frame of the inputted video, and determining the previous video frame of the target video frame as the reference video frame;
inputting the target video frame into a posture estimation model, performing posture estimation on the target video frame by using the posture estimation model, and outputting the joint point of the detected object in the target video frame; and
inputting the reference video frame into the posture estimation model, performing posture estimation on the reference video frame by using the posture estimation model, and outputting the joint point of the detected object in the reference video frame.

20. The computer-readable storage medium according to claim 19, the method further comprising:
obtaining the joint point of the detected object in the target video frame if the target video frame is the first video frame of the inputted video;
obtaining an updated detected rotation angle value, the updated detected rotation angle value representing the joint point change magnitude of the joint point, and the updated detected rotation angle value being determined based on target coordinate information of the joint point in the target video frame and default coordinate information corresponding to the joint point of a default detected object;
determining, based on the confidence range to which the target position confidence of the joint point in the target video frame belongs, an updated virtual rotation magnitude for controlling the joint point change magnitude of the joint point within the preset magnitude range; and
adjusting the updated detected rotation angle value based on the updated virtual rotation magnitude to obtain an updated adjusted rotation angle value corresponding to the joint point, the updated adjusted rotation angle value being used for performing object driving on a virtual object in a default virtual image to obtain the virtual object in a target virtual image associated with the target video frame, and the virtual object in the default virtual image being obtained by performing object simulation on the default detected object.
